(19) United States
(12) Patent Application Publication
(10) Pub. No.: US 2026/0200408 A1
(43) Pub. Date: Jul. 16, 2026

(54) SYSTEM FOR POSITIONING CARGO IN PASSENGER COMPARTMENT OF A VEHICLE

(71) Applicant: Moving Life Ltd, Netzer Sireni (IL)

(72) Inventors: Ruth REUVENI, Golan Heights (IL); Yoav GABRIELY, Yokneam Ilit (IL); Rafy DAVID, Netzer Sireni (IL)

(21) Appl. No.: 19/563,242

(22) Filed: Mar. 11, 2026

Related U.S. Application Data
(63) Continuation-in-part of application No. PCT/IL2024/050922, filed on Sep. 12, 2024.

(30) Foreign Application Priority Data
Sep. 12, 2023 (IL) 305895

(51) Int. Cl. B60R 7/04; B60R 7/08

(52) U.S. Cl. CPC B60R 7/043; B60R 7/08

(57) ABSTRACT

A system for introducing cargo onto, and removing it from, a seat of a passenger compartment of a vehicle through a door frame of a corresponding vehicle side door is disclosed. The seat has at least one safety element for indirectly fastening a passenger to the seat. The system comprises a base having at least one connection element detachably securable to the seat by means of the safety element, and a moving mechanism operable for moving cargo along at least part of a path extending between a surface outside the vehicle and the base mounted on the seat. In some embodiments, the system further comprises a cargo carrying member movable between a retracted position adjacent the base and an extended position outside the vehicle, movement occurring along a track including interior and exterior track components, the interior component optionally pivotable relative to the base.

### TECHNOLOGICAL FIELD

The presently disclosed subject matter is in the field of systems for introducing heavy cargo, e.g. a wheelchair, from the ground into the passenger compartment of vehicles such as cars, and vice versa.

### BACKGROUND

Systems of the above kind are disclosed, for example in U.S. Pat. No. 5,096,361A, JP6379440B2, JP2021074505A and JP2008114013A.

U.S. Pat. No. 5,096,361A discloses a device for loading and unloading a wheelchair into and out of a motor vehicle, consisting of a horizontal carriage track mounted transversely on the floor of the vehicle and extending the length of the compartment behind the front seat. A carriage block is slidably engaged with the carriage track and connected to a motor-actuated screw drive that causes it to slide along the track on command. An arm with a wheel-support track assembly conforming to the front wheels of a standard wheelchair is pivotally attached to the carriage block and can be extended to the outside of the vehicle to receive the folded wheelchair and move it in and out of the vehicle as the arm is retracted or extended as a result of the carriage block sliding across the track. The device is controlled by a single switch operable from the driver's seat.

JP6379440B2 discloses a wheelchair housing device which is installed in the vicinity of an opening of a vehicle and houses a wheel chair in a room. The wheelchair storage device can comprise an interior mounting portion mounted in an interior of a vehicle, a fixed arm supported on a base end side of the interior mounting portion, a movable arm supported on the fixed arm so as to be capable of advancing and retreating in a longitudinal direction, and a wheelchair holding portion provided on the movable arm and configured to hold a wheelchair; A forward/backward drive unit that drives the movable arm to advance and retreat with respect to the fixed arm, wherein the fixed arm rotates in a lateral direction between a protruding position at which a distal end side of the fixed arm faces an opening of the vehicle and a housed position different from the protruding position, and wherein the movable arm is supported by the fixed arm so as to move toward a distal end side of the fixed arm and extend, thereby being lowered. The interior mounting portion includes: a base portion that is placed on a floor near an opening and supports a base end side of the fixed arm; and a fixing portion that detachably fixes the base portion to a peripheral member of the vehicle.

JP2021074505A discloses a vehicle loading/unloading device which eliminates the necessity to allow a vehicle to be exclusive for a wheelchair user, facilitates loading/unloading, and also reduces a cost. A wheelchair includes a body frame, a sitting seat, and a support body. The support body detachably supports the sitting seat. A placement body is constituted to place the sitting seat and also to be placed on a sitting part of a vehicle seat arranged inside a vehicle. A guide rail, where one end is connectable to the support body and the other end is connectable to the placement body, guides a movement of the sitting seat between the support body and the placement body.

JP2008114013A discloses a solution for detachably mounting a lifter for mainly raising and lowering a wheelchair without remodeling a car body. The solution comprises a securing baseplate molded from an FRP material or others detachably secured and installed on a floor panel from which a rear seat of a vehicle is removed by using an existing fastening means arranged in a vehicle interior for example securing bolts of the rear seat, and a base portion of the lifter detachably secured to the base plate. The lifter can be easily secured to the floor panel without substantially remodeling the vehicle interior of the vehicle rear portion, because of using the existing fastening means. A decrease in the rigidity of the floor panel can be prevented because there is no need to newly form bolt holes in the floor panel. Original rear portion vehicle interior environment can be easily regenerated when the lifter is not needed.

U.S. Pat. No. 7,070,059B1, JP3170471U and JP2003180753A2 disclose examples of systems for introducing a wheelchair into the trunk compartment of a vehicle.

U.S. Pat. No. 7,070,059B1 discloses an improved hoist is disclosed to reposition a load relative to a vehicle compartment such as a trunk of a vehicle. The hoist comprises a base for location on a generally horizontal lower surface of the vehicle compartment. A horizontal telescoping shaft has a first and second distal end extending from opposed sides of the base for engaging with opposed generally vertical surfaces of the vehicle compartment. A horizontal expander coacts between the first and second distal ends for applying a horizontal engaging force between the opposed generally vertical surfaces of the vehicle compartment for horizontally stabilizing the base within the vehicle compartment. A vertical telescoping shaft having a distal end extends vertically from the improved hoist for engaging with a upper generally horizontal surface of the vehicle compartment. A vertical expander coacts between the base surface and the distal end of the vertical telescoping shaft for applying a vertical engaging force between the lower and upper generally horizontal surfaces of the vehicle compartment for vertically stabilizing the base within the vehicle compartment. A column extends from the base for supporting a boom for repositioning the load relative to the vehicle.

JP3170471U discloses a wheelchair lifting device having a relatively simple structure and a large operating range. A rotation center shaft is provided substantially vertically with a lower end portion thereof being horizontally rotatably attached to an automobile body; a first arm portion attached so as to be able to swing about the substantially horizontal axis; and an angle with the first arm portion on the distal end side of the first arm portion. and an actuator connected to the rotation center axis and the first arm portion, and a belt-type lifting portion attached to the second arm portion.

JP2003180753A2 discloses a wheelchair housing device which allows placement of the wheelchair on a floor surface for the stabilization of the wheel chair when it is housed in a vehicle, and shows excellent workability without having the wheelchair stuck on the floor surface of the vehicle or a bumper during the operation. The path of a parallel link mechanism is controlled to raise a wheelchair supporting arm perpendicularly when the wheelchair supporting arm is moved from a state where the wheelchair is housed in the vehicle to the outside of the vehicle. Then, a lock mechanism is activated to lock the parallel link mechanism at a prescribed angle by controlling the movements of a lock member. The wheelchair supporting arm, the parallel link mechanism, and a control link are rotated in an incorporated manner.

### GENERAL DESCRIPTION

According to one aspect of the presently disclosed subject matter, there is provided a system mountable to an upper surface of a seat in a passenger compartment of a vehicle, such as a car, adjacent a corresponding door frame thereof, by means of at least one safety element of the seat intended for at least indirectly securely fastening to the seat a passenger sitting on the seat upper surface, for introducing a cargo thereto or removing it therefrom. The system can have, an interior portion having at least one connection element detachably securable to the seat by means of said at least one safety element, and a moving mechanism operable for moving cargo at least along a part of a path extending via the door frame between a surface at the exterior of the vehicle, such as the ground, from which the cargo is to be raised, and the interior portion of the system when mounted to the upper surface of the seat.

The interior portion of the system can comprise a base having a base longitudinal axis, a seat facing surface and an opposite, cargo facing surface defining a base plane and being mountable to the seat by means of secure engagement of said at least one connection element with said at least one safety element of the seat, and said moving mechanism can be operable for moving cargo along at least a part of the path between of the exterior of the vehicle and the base when mounted to the upper surface of the seat.

According to another aspect of the presently disclosed subject matter, the path can be constituted at least partially by a track along which the moving mechanism can move cargo at least indirectly. The track can comprise, at least in operation, an interior track component which can be mounted to the cargo facing surface of a base when a system comprises such base, or which can constitute the base of the system (when the system does not have another base and the interior track component is mounted to the seat at least indirectly by the corresponding connection elements engageable with the safety elements of the seat). The track can further comprise an exterior track component detachable attachable to, or mounted in an extendable manner to the interior track component, to extend therefrom to the exterior of the vehicle as described above.

According to a further aspect of the presently disclosed subject matter, which can be used in any of the aspects described above or below where the system comprises a track having an interior and an exterior component, the track can have an aligned mutual disposition of these components, in a storage state of the system, in which the entire system can be completely within boundaries of a vehicle, and an extended mutual disposition of these components, in a operational state of the system, in which the system is operable for introducing cargo onto, and removing it from, a seat of a passenger compartment of a vehicle through a door frame of a corresponding vehicle side door. The exterior track component can be mountable to the interior track component in a way that it is movable outwardly to be brought into the extended disposition relative to the interior track position. This movement can be sliding along and aside of the interior track component, or one component can be telescopically received in the other to allow sliding of the exterior components relative to the interior track component.

According to a further aspect of the presently disclosed subject matter, there is provided a track for slidingly moving therealong a cargo at least indirectly, for introducing the cargo onto, and removing the cargo from, a seat of a passenger compartment of a vehicle through a door frame of a corresponding vehicle side door, along a path, the track when in operation having a front view as seen from the front of the vehicle, a plan view as seen from above the track and a side view as seen towards or away from the door frame of the vehicle, the track at least in operation comprising, at least an exterior track component, said exterior track component comprising an exterior track proximal section with an exterior track proximal end, an exterior track distal section with an exterior track distal end, a tangent to the exterior track distal section being oriented at an obtuse angle with respect to a tangent to the exterior track proximal portion in the front view of the track. The track according to this aspect can be used in a system according to any of the aspects described above or below.

According to a still further aspect of the presently disclosed subject matter, which can be used in any of the aspects described above or below, the system can further comprise a cargo carrying member moveable by said moving mechanism along said path via said door frame between a retracted position in which at least a majority of the cargo carrying member is positioned at least indirectly on the base or on the interior track component and an extended position in which said cargo carrying member is spaced from the seat at least along a longitudinal axis thereof at least in the plan view of the system, to allow the cargo carrying member to be located outside of the vehicle.

According to a still further aspect of the presently disclosed subject matter, which can be used in any of the aspects described above or below where the system comprises a base, the base can have front and rear boundaries defining a width of the base which extends at least partially along the depth of the seat when the base is secured thereto, and inboard and outboard side boundaries defining therebetween a length of the base along the base longitudinal axis.

According to a still further aspect of the presently disclosed subject matter, which can be used in any of the aspects described above or below, the system can have an operational state in which the system is operable for introducing cargo onto, and removing the cargo from, a seat of a passenger compartment of a vehicle through a door frame of a corresponding vehicle side door, and a storage state in which at least a majority of said cargo carrying member with or without said cargo is located within said boundaries of said base.

According to a still further aspect of the presently disclosed subject matter, which can be used in any of the aspects described above or below where the system comprises a track, the cargo carrying member can comprise a track facing surface which faces the track along the entire movement of the cargo carrying member, and a cargo fixing apparatus operable to fixedly receive the cargo. The cargo fixing apparatus can be operable to maintain a constant orientation with respect to the track facing surface during movement of the cargo carrying member between the extended and retracted positions of the cargo carrying member.

The moving mechanism can be operable for moving cargo or cargo carrying member along at least a part of the path described above. Particularly, the moving mechanism can be operable for moving cargo or cargo carrying member along at least a majority of the path or along the entire path. The moving mechanism can be motorized or manually operated, or these two modes can be combined. According to a further aspect of the presently disclosed subject matter, when a system of any of the above aspects comprises a base with a cargo facing surface and a seat facing surface, the system can further comprise an orientation mechanism operable to adjust the orientation of the cargo facing surface with respect to the seat facing surface of the base at least when the base is mounted to the seat with its seat facing surface being parallel to the upper surface of the seat. In this case, the orientation mechanism is operable to change the orientation of the cargo facing surface by changing its inclination angle relative to the seat facing surface.

According to a further aspect of the presently disclosed subject matter, the above-mentioned path in a system of any of the previous aspects can include at least one angled vector component, and the base can define a plane. A projection of the at least one angled vector component onto the plane can be oriented at an angle relative to a projection of the base longitudinal axis onto the plane. The path can further have a path proximal portion associated with a maximally retracted position of the cargo carrying member, and a path distal portion associated with a maximally extended position of the cargo carrying member. One of or each of the proximal and distal path portions can comprise at least one angled vector component. The at least one angled vector component can be constituted by an askew vector component oriented askew to the base longitudinal axis.

According to a further aspect of the presently disclosed subject matter, there is provided a track for moving a cargo therealong for introducing the cargo onto, and removing the cargo from, a seat of a passenger compartment of a vehicle through a door frame of a corresponding vehicle side door, the track at least in operation having a shape whose central axis defines the above path at least along an exterior track component. More particularly, in an embodiment of the presently disclosed subject matter, the exterior track component can have an exterior track proximal section with an exterior track proximal end; and an exterior track distal section with an exterior track distal end, the exterior track distal section being oriented at least partially at an obtuse angle with respect to the exterior track proximal portion in the front view of the track and being spaced therefrom at least in the side view of the track.

The directions with respect the views of a track or any other subject described in the present description and Embodiments are normally as follows: the front view is as seen from the front of the vehicle, a plan view as seen from above and a side view as seen towards or away from the door frame of the vehicle.

The above track can further comprise an interior track component mountable at least indirectly to said seat by means of at least one safety element of the seat intended for securing to the seat a passenger sitting thereon, the interior track component having an interior track inboard end and an interior track outboard end.

A system according to any of the previously described aspects or any aspect described below can have one or more safety barrier mountable to the base and/or the backrest of the seat, to restrict the movement of cargo relative to the base.

According to a still further aspect of the presently disclosed subject matter, a system of any of the above aspects when used with a track having an interior and exterior track components, can comprise a ground support member having an adjustable height and connectable to the exterior track distal end of the exterior track component and extendable therefrom downwardly to engage a surface from which the cargo is to be raised.

According to a further aspect of the presently disclosed subject matter, a system according to any aspect described above, when having a base mountable to the seat by means of one or more of safety elements thereof, further comprises at least in operation, a front support member mountable to a corresponding front support member receiving port located at the front end of the base, so that it constitutes a front support leg for the base.

The at least one or more safety elements of the vehicle, with which at least one connection element of a system according to any of the above aspects, is engageable, can be constituted by at least one ISOFIX element. The at least one connection element can two connection elements spaced to the same distance as that between corresponding two safety elements of the seat, with which the connection elements are engageable.

According to a still further aspect of the presently disclosed subject matter, which can be used in any of the aspects described above or below where the system comprises a base having at least one connection element, the base can have a rear portion and a front portion including respective rear and front boundaries of the base. The at least one connection element can be securely fixed to the rear portion of the base so as to project rearwardly from the rear boundary of the base for engaging with the corresponding at least one safety element.

In a system according to any of the previously described aspects, the cargo carrying member, if any, can comprise a cargo fixing apparatus operable to fixedly receive the cargo and comprising a bottom support surface operable to contact a first side of the cargo and a side support surface operable to contact a second side of the cargo. The cargo fixing apparatus can be manipulable between an initial state in which the bottom support surface is oriented horizontally enabling it to bear at least most of the cargo weight and an inclined state in which each of said support surfaces is angled with respect to its orientation in the initial state of the unit so as to allow at least a part of the cargo weight to be borne by the side support surface. The cargo carrying member can further comprise at least one track engaging element configured to slidingly engage said track. The at least one track engaging element can be constituted by at least two wheels. The cargo fixing apparatus can be at least indirectly connected to the at least one track engaging element so as to be moveable thereby along said track.

According to a further aspect of the presently disclosed subject matter, which can be used in any of the aspects described above or below where the system comprises a track having an interior track component and an exterior track component, the exterior portion of the longitudinal central track axis can define an obtuse angle with the base plane, thereby providing the cargo carrying member with an inclined orientation relative to the base plane when moving along the path distal portion.

According to a further aspect of the presently disclosed subject matter, which can be used in any of the aspects described above or below where the system comprises a track having an interior track component, the interior track component can be pivotably mounted to the base adjacent the interior track outboard end thereof. The interior track component can be pivotable between an inclined orientation in which the interior track inboard end is spaced from the base plane to a first height, and a planar orientation in which the interior track inboard end is spaced from the base plane to a second height smaller than the first height. In the inclined orientation, the interior track component can be oriented at a first inclination angle relative to the base plane, and in the planar orientation, the interior track component can be oriented at a second inclination angle relative to the base plane, wherein the second inclination angle is smaller than the first inclination angle. The inclination angle can be defined between a line coincident with the interior track component central axis and a reference line parallel to the base plane. In both the inclined and planar orientations, the interior track outboard end can maintain a location thereof relative to the cargo facing surface. The inclined orientation of the interior track component can define an inclined orientation of the path proximal portion, thereby providing the cargo carrying member with an inclined orientation relative to the base plane when moving along the path proximal portion.

According to a still further aspect of the presently disclosed subject matter, which can be used in any of the aspects described above or below where the interior track component is pivotably mounted to the base, the system can further comprise at least one biasing element operably connecting the base and the interior track component. The biasing element can bias the interior track component toward the inclined orientation. The biasing element can be configured to maintain the interior track component in the inclined orientation thereof, at any weight of cargo for which the system is designed, when at least a majority of the cargo carrying member is located along the path proximal portion.

According to a still further aspect of the presently disclosed subject matter, which can be used in any of the aspects described above or below, the moving mechanism can comprise a hoist apparatus including at least one cable windable on a spool and attached to the cargo carrying member at least when the system is in the operational state thereof. The hoist apparatus can further comprise a motor operable to rotate the spool, and an anchoring member to which an anchorable end of the cable is fixedly connected.

According to a still further aspect of the presently disclosed subject matter, which can be used in any of the aspects described above or below where the system comprises a biasing element and a hoist apparatus, upward movement of the cargo carrying member along the path distal portion and path proximal portion can be provided by means of retraction of the cable until the cargo carrying member reaches a stage at which continued retraction of the cable causes compression of the at least one biasing element to pivot the interior track component from the inclined orientation toward the planar orientation. During movement of the cargo carrying member from the maximally retracted position thereof along the path proximal portion, extension of the cable can permit the at least one biasing element to bias the interior track component toward the inclined orientation thereof prior to the cargo carrying member reaching the path distal portion.

According to a still further aspect of the presently disclosed subject matter, which can be used in any of the aspects described above or below where the interior track component is pivotably mounted to the base, the exterior track component can be shorter than in systems having a non-pivotable interior track component. The exterior track distal end can be positioned at a height above the surface from which the cargo is to be raised, such that the track need not extend all the way to the surface. The cargo carrying member can be configured to pivot about the exterior track distal end between a loading position, in which the cargo fixing apparatus thereof is in the initial state with the bottom support surface oriented horizontally to facilitate loading of cargo thereon, and a travelling position, in which the cargo fixing apparatus is in the inclined state and the cargo carrying member is aligned with the exterior track component for movement therealong.

According to a still further aspect of the presently disclosed subject matter, which can be used in any of the aspects described above or below where the system comprises a track having an interior track component and an exterior track component, the exterior track component can comprise a fixation member at the exterior track proximal end thereof, the fixation member being operable to detachably attach the exterior track proximal end to the interior track outboard end of the interior track component.

According to a still further aspect of the presently disclosed subject matter, which can be used in any of the aspects described above or below where the interior track component is pivotably mounted to the base, movement of the cargo carrying member in a direction away from the base can occur under the influence of gravity along both the interior track component and the exterior track component when the interior track component is in the inclined orientation thereof.

It will also be appreciated that a system according to the presently disclosed subject matter, and particularly, of any of the aspects described above or below, can alternatively be mountable in a trunk compartment of a vehicle by means of at least one anchorage point of the vehicle provided in the trunk compartment, for example ISOFIX anchorage points and/or tether anchors.

In all of the aspects described above, and the embodiments described below and described in the detailed description and defined in the claims, the system is described in a state in which it is mountable to a vehicle.

Additional aspects and embodiments of the presently disclosed subject matter are listed in the following:
1. A system for introducing cargo onto, and removing it from, a seat of a passenger compartment of a vehicle through a door frame of a corresponding vehicle side door, the seat having a seat longitudinal axis and a seat upper surface having a dimension defining a seat depth perpendicular to the longitudinal axis, the seat having at least one safety element for at least indirectly securely fastening to the seat a passenger sitting on the seat upper surface, the system comprising at least in use:
   (i) a base having a base longitudinal axis, a seat facing surface and an opposite, cargo facing surface, the base further having
      at least one connection element detachably securable to the seat by means of said at least one safety element, with the base longitudinal axis being parallel to the seat longitudinal axis and the seat contacting surface being parallel to the upper surface of the seat;
      front and rear boundaries defining a width of the base which extends at least partially along the depth of the seat when the base is secured; and
      inboard and outboard side boundaries defining therebetween a length of the base along the base longitudinal axis;
   (ii) a cargo carrying member moveable with respect to the base along a path between a retracted position in which at least a majority of the cargo carrying member overlies at least partially the cargo facing surface of the base, and an extended position in which said cargo carrying member is spaced from the cargo facing surface of the base at least along the longitudinal axis thereof at least in the plan view of the system, to allow the cargo carrying member to be located outside of the vehicle; and
   (iii) a moving mechanism operable for moving the cargo carrying member, at least indirectly, between the extended and retracted positions via the door opening, at least along a part of said path.
2. A system according to Embodiment 1 wherein said moving mechanism comprises a hoist system comprising, at least in use:
at least one cable having a spool end and an anchorable end, at least one spool on which the corresponding cable is windable and to which said spool end of the
cable is fixedly connected, the spool being rotatable, optionally by a motor, to cause the cable to change its length between the spool and the anchorable ends thereof, and at least one anchoring member to which the corresponding anchored end of the cable is fixedly connected,
the at least one spool and motor, if any, being mounted to one of said cargo carrying member and said base, and said at least one anchoring member being mounted to the other of the cargo carrying member and the base.
3. A system for introducing cargo onto, and removing it from, a seat of a passenger compartment of a vehicle through a door frame of a corresponding vehicle side door, the seat having a seat longitudinal axis and a seat upper surface having a dimension defining a seat depth perpendicular to the longitudinal axis, the seat having at least one safety element for at least indirectly securely fastening to the seat a passenger sitting on the seat upper surface, the system comprising at least in use:
   (i) a base having a base longitudinal axis, a seat facing surface and an opposite, cargo facing surface, the base further having
      at least one connection element detachably secured to the seat by means of said at least one safety element, with the base longitudinal axis being parallel to the seat longitudinal axis and the seat contacting surface being parallel to the upper surface of the seat;
      front and rear boundaries defining a width of the base which extends at least partially along the depth of the seat when the base is secured thereto; and
      inboard and outboard side boundaries defining therebetween a length of the base along the base longitudinal axis;
   (i) a cargo carrying member moveable with respect to the base along a path between a retracted position in which at least a majority of the cargo carrying member overlies at least partially the cargo facing surface of the base and is positioned between the boundaries of the base at least in the plan view of the system, and an extended position in which said cargo carrying member is spaced from the carrying member facing surface of the base at least along the longitudinal axis thereof at least in the plan view of the system to allow the cargo out of the vehicle via said door frame; and
   (ii) a moving mechanism comprising a hoist system, said hoist system comprising
   at least one cable having a spool end and an anchorable end; at least one spool on which the corresponding cable is windable and to which said spool end of the cable is fixedly connected; the spool being rotatable, optionally, by a motor, to cause the cable to change its length between the spool and the anchorable ends thereof; and at least one anchoring member to which the corresponding anchored end of the cable is fixedly connected;
   the at least one spool and the motor, if any, being mounted to one of said cargo carrying member and said base, at least indirectly, and said at least one anchoring member being mounted to the other of the cargo carrying member and the base.
4. A system according to Embodiment 2 or 3, wherein said at least one anchoring member is mounted at least indirectly to the base, and the motor and at least one spool are mounted on the cargo carrying member.
5. A system according to Embodiment 4, wherein said base comprises a driving surface associated with the carrying member facing surface, and the moving mechanism further comprises at least one wheel attached to the cargo carrying member and rotatable along said driving surface to allow movement of the cargo carrying member at least along said base in a direction away from the inward boundary of the base.
6. A system according to Embodiment 5, wherein spool comprises an outer surface engageable with the driving surface, said spool with said outer surface constituting said wheel.
7. A system according to any one of Embodiments 1 to 6, wherein the system further comprises a an orientation mechanism operable to adjust the orientation of the cargo facing surface with respect to the seat facing surface of the base at least when the base is mounted to the seat with its seat facing surface being parallel to the upper surface of the seat, and wherein optionally, the orientation mechanism being operable to change the orientation of the cargo facing surface by changing its inclination angle relative to the seat facing surface.
8. A system according to any one of the preceding Embodiments, wherein said path includes at least one askew vector component oriented at an angle that is askew to said base longitudinal axis at least in the plan view of the system.
9. A system according to Embodiment 8, wherein the path has a path distal portion associated with a maximally extended position of the cargo carrying member, a path proximal portion associated with a maximally retracted position of the cargo carrying member, and a path intermediate portion therebetween, comprising said at least one askew vector component.
10. A system according to Embodiment 9, wherein at least the part of the path, along which the moving mechanism is operable to move the cargo, at least indirectly, comprises said first, second and intermediate path portions, and wherein at least the first portion comprises a vertical vector component and at least the second portion comprises a horizontal vector component.
11. A system according to any of Embodiments 9 or 10, wherein the intermediate path portion comprises at least one of vertical and horizontal vector components, in addition to the askew vector component.
12. A system according to any one of the preceding Embodiments, wherein said moving mechanism is operable to move the cargo carrying member along a majority of said path.
13. A system according to any one of the preceding Embodiments, wherein the system comprises a track having a central track axis representing at least a portion of the path.
14. A system according to Embodiment 13, wherein said track comprises at least an interior track component disposed on the cargo facing surface of the base and extending along an interior portion of the track central axis parallel to or coincident with the base longitudinal axis at least along a portion thereof; the interior track component having an interior track inboard end adjacent the inboard side boundary of the base and an interior track outboard end adjacent with the outboard side boundary of the base.
15. A system according to Embodiment 14, wherein said track further comprises an exterior track component extending along an exterior portion of the track central axis and having an exterior track proximal section with an exterior track proximal end detachably attachable to the interior track outboard end, an exterior track distal section with an exterior track distal end spaced from exterior track proximal end along the track central axis, and an exterior track intermediate section therebetween.
16. A system according to Embodiment 15 when dependent at least indirectly on Embodiment 9, wherein said interior track component defines said path proximal portion and said exterior track component has a curved shape and defines said path distal and intermediate portions.
17. A system for introducing cargo onto and removing it from a seat in a passenger compartment of a vehicle through a door frame of a corresponding vehicle side door, the seat having a seat longitudinal axis and a seat upper surface having a dimension defining a seat depth perpendicular to the longitudinal axis, and the seat having at least one safety element for at least indirectly securely fastening to the seat a passenger sitting on the seat upper surface, the system comprising at least in use:
   (i) a base having a base longitudinal axis, a seat facing surface and an opposite, cargo facing surface, the base further having
      at least one connection element detachably secured to the seat by means of said at least one safety element, with the base longitudinal axis being parallel to the seat longitudinal axis and the seat contacting surface being parallel to the upper surface of the seat;
      front and rear boundaries defining a width of the base which extends at least partially along the depth of the seat when the base is secured thereto; and
      inboard and outboard side boundaries defining therebetween a length of the base along the base longitudinal axis;
   (ii) a track having a central axis and comprising
      an interior track component disposed on said base, extending along an interior portion of said central axis, and having inboard and outboard track ends adjacent, respectively, the inboard and outboard side boundaries of the base, and
      an exterior track component extending along an exterior portion of said central axis and having a body comprising an exterior track proximal section with an exterior track proximal end, an exterior track distal section with an exterior track distal end, and an exterior track intermediate section therebetween, said exterior track proximal end being detachably connectable to said outboard track end of said interior track component,
   (iii) a moving mechanism operable for moving cargo, at least indirectly along said track; and
   (iv) a safety barrier at least indirectly securable at least to the base to restrict the movement of a cargo with respect to the interior track component when the cargo is at least indirectly positioned to the base, said safety barrier being constituted by the body of the exterior track component detached from said exterior track end of said interior track component.
18. A system according to Embodiment 17, further comprising a cargo carrying member moveable with respect to the base along a path between a retracted position in which at least a majority of the cargo carrying member overlies at least partially the cargo facing surface of the base and is positioned between the front and rear boundaries of the base at least in the plan view of the system, and an extended position in which said cargo carrying member is spaced from the carrying member facing surface of the base at least along the longitudinal axis thereof at least in the plan view of the system to allow the cargo carrying member to be moved via said door frame to the base from outside the vehicle and vice versa.
19. A system according to Embodiment 18, wherein said moving mechanism comprises a hoist system comprising, at least in use:
at least one cable having a spool end and an anchorable end,
at least one spool on which the corresponding cable is windable and to which said spool end of the cable is fixedly connected, the at least one spool being rotatable, optionally, by a motor, and at least one anchoring member to which the corresponding anchored end of the cable is fixedly connected;
the at least one spool and the motor, if any, being mounted to one of said cargo carrying member and said base, and said at least one anchoring member being mounted to the other of the cargo carrying member and the base, all being operable to move the cargo carrying member from the extended position to the retracted position.
20. A system according to any one of Embodiments 15 to 19, wherein said interior portion of said central axis of the track defines a path proximal portion and said exterior portion of said central axis of the track defines a path intermediate portion and a path distal portion, said path intermediate and path distal portions being angled relative to each other.
21. A system according to any one of Embodiments 15 to 20, wherein one of the exterior track proximal and distal ends is securable at least indirectly to the base adjacent the front boundary thereof when said exterior track element constitutes the safety barrier, to at least partially serve as a front safety barrier for the cargo when positioned at least indirectly on the base, when the exterior track is detached from the interior track component.
22. A system according to Embodiment 21, wherein the other of said exterior track distal and proximal ends is detachably attachable at least indirectly to a backrest of said seat so as to serve as an upper safety barrier for the cargo when positioned at least indirectly on the base.
23. A system according to Embodiment 22, wherein the proximal end of said exterior track component comprises a fixation member operable to fixedly and detachably attach to the outboard end of the interior track component, and alternatively to fixedly and detachably attach to the proximal end of the exterior track to one of the base or the backrest.
24. A system according to Embodiment 23, wherein the base has a port adjacent its front boundary, and the fixation member is operable to fixedly attach to said port.
25. A system according to Embodiment 24, further comprising a barrier connecting element fixedly and detachably securable to a backrest at least partially by means of at least one safety element of the vehicle.
26. A system according to Embodiment 25, wherein the distal end of the exterior track component is operable to fixedly and detachably attach to said barrier connecting element.
27. A system according to any one of Embodiments 14 to 26, wherein the interior track inboard end of said interior track component comprises a vertical extension constituting a side safety barrier.
28. A system according to any of one Embodiments 15 to 27, further comprising a ground leg having an adjustable height and connectable to the exterior track distal end of the exterior track component and extendable therefrom downwardly to engage a surface from which the cargo is to be raised.
29. A system according to any one of Embodiments 15 to 29, wherein the interior and exterior track components each comprise two rails located on two sides and parallel to said central axis of the track.
30. A system according to any one of the preceding Embodiments, wherein said system, at least in use, further comprises a front support member mountable to a corresponding front support member receiving port located at the front end of the base, so that a lower portion of the front support member constitutes a front support leg for the base, and an upper portion of the front support member constitutes a front movement preventing member of the base.
31. A system according to Embodiment 31, wherein said lower and upper portions extend away from the port in opposite sides.
32. A system according to Embodiment 31 or 32 when dependent at least indirectly on Embodiment
23, wherein said upper portion comprises a receiving port operable to fixedly and detachably receive a fixation member of exterior track component.
33. A system according to any one of the preceding Embodiments, wherein said at least one connection element is engageable with at least one ISOFIX element constituting said at least one safety element of the vehicle.
34. A system according to Embodiment 33, wherein the base has a rear portion and a front portion including the respective rear and front boundaries of the base.
35. A system according to Embodiment 34, wherein said at least one connection element is securely fixed to the rear portion of the base so as project rearwardly from the rear boundary of the base for engaging with the corresponding at least one safety element.
36. A system according to any one of Embodiments 33 to 35 wherein said at least one connection element comprises two connection elements spaced along the base longitudinal axis to the same distance as that between corresponding two safety elements of the seat, with which the connection elements are engageable.
37. A system according to Embodiment 36, wherein the two connection elements are in the form of ISOFIX connectors and the corresponding safety elements are in the form of ISOFIX anchorage points.
38. A system according to any one of the preceding Embodiments, wherein said at least one connection element comprises at least one slot shaped to receive a corresponding safety element in the form of a seat belt.
39. A system according to Embodiment 38, wherein said at least one slot is constituted by two slots formed at the rear portion of the base.
40. A system according to Embodiment 39 when indirectly dependent on Embodiment 33, wherein the two slots are located above the two ISOFIX connectors.
41. A system according to any one Embodiments 1 to 16, 18, or 19 to 40 when dependent at least indirectly on Embodiment 18, wherein said cargo carrying member comprises a cargo supporting unit operable to fixedly receive the cargo and comprising a bottom support surface operable to contact a first side of the cargo and a side support surface operable to contact a second side of the cargo at least when the cargo carrying member with the cargo is moved along said path.
42. A system according to Embodiment 41, wherein said cargo supporting unit is manipulable between an initial state in which the bottom support surface is oriented horizontally enabling it to bear at least most of the cargo weight and an inclined state in which each of said support surfaces is angled with respect to its orientation in the initial state of the unit so as to allow at least a part of the cargo weight to be borne by the side support surface.
43. A system according to any one Embodiments 1 to 16, 18, or 19 to 36 when dependent at least indirectly on Embodiment 18, or 37 to 29, wherein said cargo carrying member comprises at least one track engaging element configured to slidingly engage said track.
44. A system according to Embodiment 43, wherein said at least one track engaging element is constituted by at least two wheels.
45. A system according to Embodiment 43 or 44, wherein at least in the inclined state, the cargo supporting unit is at least indirectly connected to the at least one track engaging element so as to be moveable thereby along said path.
46. A track for slidingly moving therealong a cargo at least indirectly, for introducing the cargo onto, and removing the cargo from, a seat of a passenger compartment of a vehicle through a door frame of a corresponding vehicle side door, the track in use having a front view as seen from the front of the vehicle, a plan view as seen from above the track and a side view as seen towards or away from the door frame of the vehicle, the track at least in use comprising at least an exterior track component having
   an exterior track proximal section with an exterior track proximal end detachably attachable at least indirectly to the seat;
   an exterior track distal section with an exterior track distal end, the exterior track distal section being oriented at least partially at an obtuse angle with respect to the exterior track proximal portion in the front view of the track and being spaced therefrom at least in the side view of the track; and
   an exterior track intermediate section between the exterior track proximal and distal portions having a curved shape and being oriented at least partially askew to the exterior track distal and proximal sections at least in the plan view of the track.
47. A track according to Embodiment 46, further comprising an interior track component mountable at least indirectly to said seat by means of at least one safety element of the seat intended for securing to the seat a passenger sitting thereon, the interior track component having an interior track inboard end and an interior track outboard end, to which the exterior track distal end is detachable attachable.
48. A track according to Embodiment 46 or 47, wherein the exterior track component, when not in use for introducing or removing the cargo onto or from the seat, respectively, is connectable to the seat or the cargo from within the vehicle to serve as a safety barrier for the cargo.
49. A track according to Embodiment 48, wherein one of the exterior track proximal and distal ends is securable at least indirectly to a base mountable on the seat adjacent a front boundary thereof to at least partially serve as a front safety barrier for the cargo when positioned at least indirectly on the base, when the exterior track is detached from the interior track component.
50. A track according to Embodiment 49, wherein the other of said exterior track distal and proximal ends is detachably attachable at least indirectly to a backrest of said seat so as to serve as an upper safety barrier for the cargo when positioned at least indirectly on the base.
51. A track according to Embodiment 47 or any one of Embodiments 48 to 51, when dependent on Embodiment 47, wherein the proximal end of said exterior track component comprises a fixation member operable to fixedly and detachably attach to the outboard end of the interior track component, and alternatively to fixedly and detachably attach to the proximal end of the exterior track to one of the base or the backrest.
52. A track according to Embodiment 52, wherein the base has a port adjacent its front boundary, and the fixation member is operable to fixedly attach to said port.
53. A track according to Embodiment 24, further comprising a barrier connecting element fixedly and detachably securable to a backrest at least partially by means of at least one safety element of the vehicle and wherein the distal end of the exterior track component is operable to fixedly and detachably attach to said barrier connecting element.
54. A track according to Embodiment 47 or any one of Embodiments 48 to 53 when dependent on Embodiment 47, wherein the interior track inboard end of said interior track component comprises a vertical extension constituting a side safety barrier.
55. A track according to any of one Embodiments 46 to 54, further comprising a ground leg having an adjustable height and connectable to the exterior track distal end of the exterior track component and extendable therefrom downwardly to engage a surface from which the cargo is to be raised.
56. A system according to according to Embodiment 47 or any one of Embodiments 48 to 55 when dependent on Embodiment 47, wherein the interior and exterior track components each comprise two rails located on two sides and parallel to a central axis of the track.
57. A system according to any one of the preceding Embodiments, wherein said vehicle is a car and said passenger compartment is a rear passenger compartment of the car.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates a plan view of a base according to an example of the presently disclosed subject matter.

FIGS. 2A and 2B respectively schematically illustrate a perspective view and a cross-sectional view of a system having the base illustrated in FIG. 1, mounted to a rear seat of a vehicle.

FIGS. 3A and 3B schematically illustrate perspective views of the exemplary system illustrated in FIGS. 2A and 2B, mounted a vehicle with a cargo carrying member in the extended and retracted positions respectively.

FIGS. 4A and 4B respectively schematically illustrate perspective and plan views of one example of a path which the cargo carrying member of the system shown in FIGS. 3A and 3B can be moved along.

FIGS. 4C and 4D respectively schematically illustrate perspective and plan views of another example of a path which the cargo carrying member of the system shown in FIGS. 3A and 3B can be moved along.

FIG. 5A illustrates a plan view of one example of a track according the presently disclosed subject matter.

FIGS. 5B-5D respectively illustrate perspective, exploded and front views of the track illustrated in FIG. 5A.

FIG. 6A illustrates a plan view of another example of a track according the presently disclosed subject matter.

FIGS. 6B and 6C illustrates perspective views of the track illustrated in FIG. 6A, wherein the exterior track component is in its stowed and deployed positions, respectively.

FIGS. 6D and 6E illustrates perspective views of the track illustrated in FIG. 6A-6C, wherein the exterior track component is in its stowed and deployed positions, respectively.

FIGS. 7A and 7B illustrate perspective views of the track of FIGS. 5A-5C, and an extension leg being respectively in the deployed and retracted states thereof.

FIGS. 8A and 8B illustrate perspective views of the track of FIGS. 6A-6E, and a ground support member being respectively in the deployed and retracted states thereof.

FIG. 9A illustrates one perspective view of the track of FIGS. 5A-5D and 7A-7B, with a moving mechanism and cargo carrying member according to one example of the presently disclosed subject matter mounted thereon.

FIG. 9B illustrates an opposite perspective view of the track and cargo carrying member illustrated in FIG. 9A.

FIG. 10 illustrates a perspective view of the cargo carrying member illustrated in FIGS. 9A and 9B.

FIG. 11 illustrates a portion of a system according to the presently disclosed subject matter.

FIG. 12 illustrates a portion of a cargo carrying member for use in the system illustrated in FIG. 11.

FIGS. 13A and 13B illustrate perspective views of the cargo carrying member illustrated in

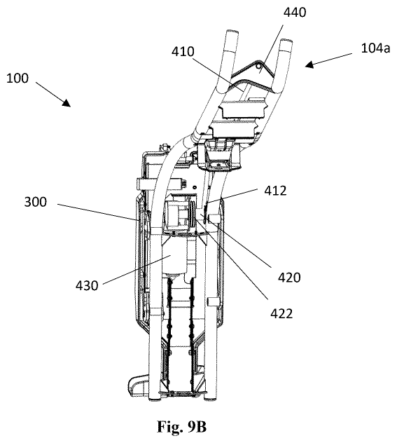

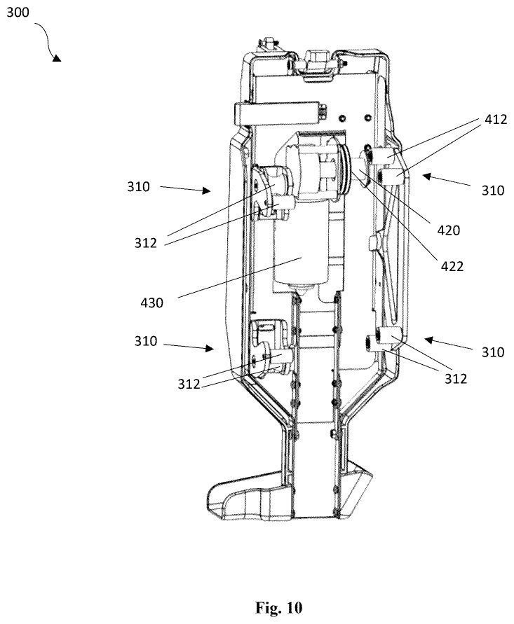

FIGS. 9A-10 , with the cargo fixing apparatus thereof being respectively in the initial and inclined states thereof.

FIGS. 14A and 14B illustrate perspective views of the cargo carrying member illustrated in

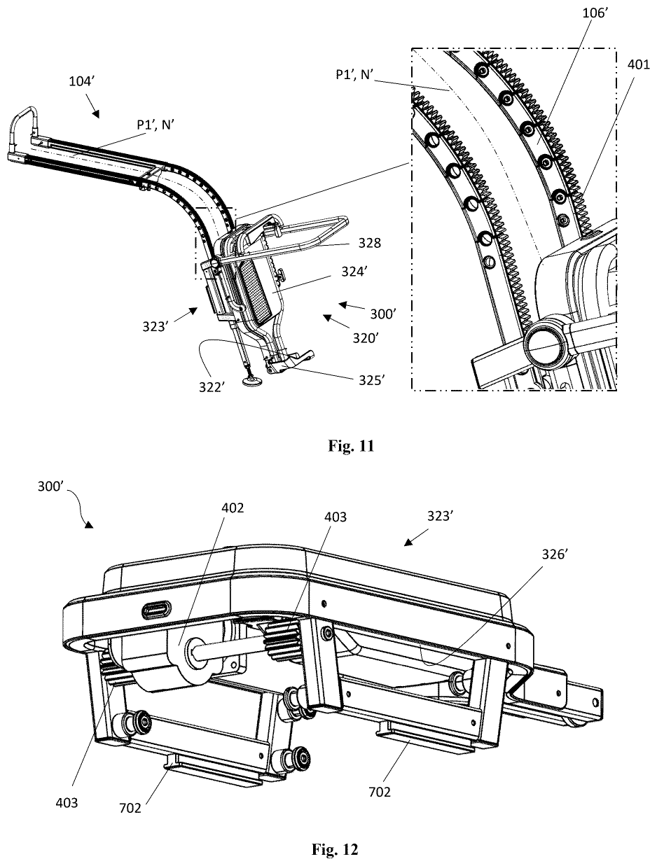

FIGS. 11 and 12, with the cargo fixing apparatus thereof being respectively in the initial and inclined states thereof.

FIG. 15 illustrates a perspective view of a base, according to an example of the presently disclosed subject matter with an interior track component mounted thereto.

FIG. 16A illustrates a perspective view of another example of a base, according to an example of the presently disclosed subject matter.

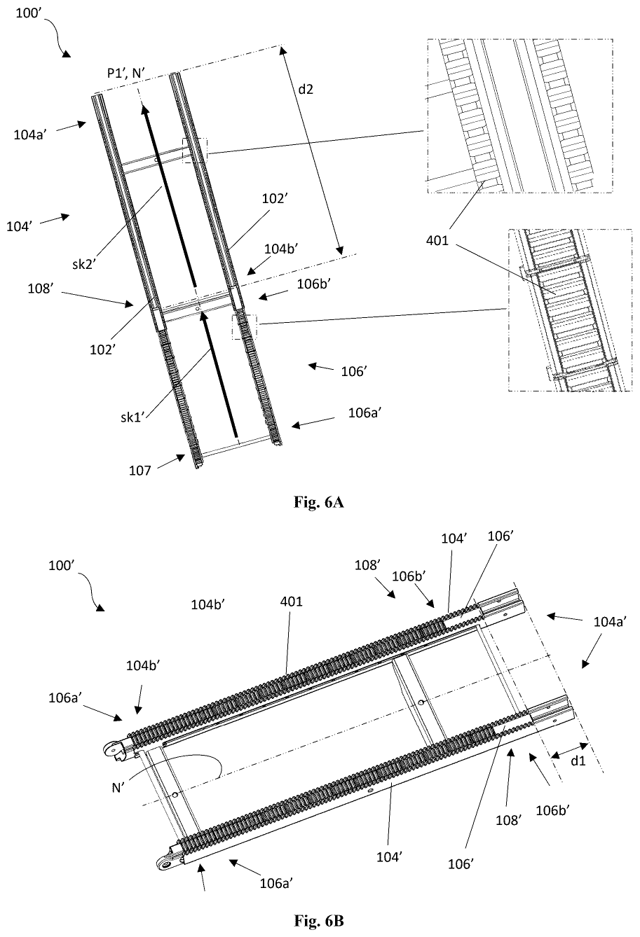

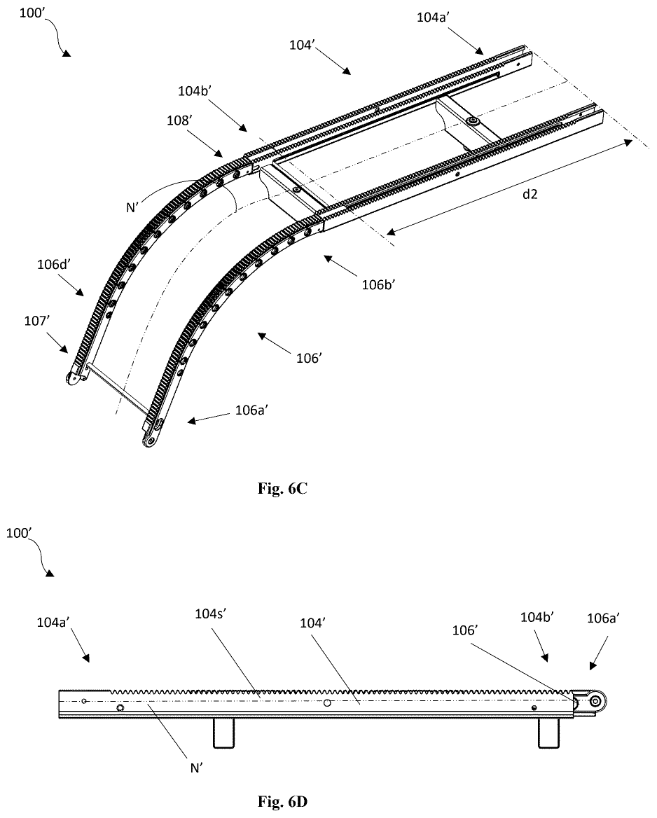

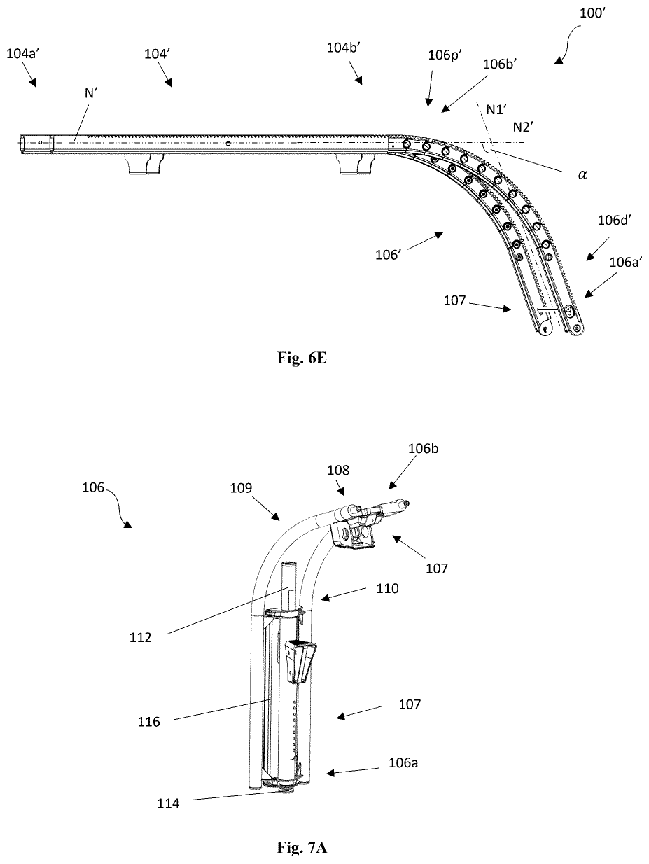

FIGS. 16B-16D illustrate plans view of the interior track component illustrated in FIGS. 6A-6E, rotatably mounted to the base illustrated in FIG. 16A, in the transverse orientation, the intermediate storage position and the final storage position thereof, respectively.

FIG. 17 illustrates a perspective view of the base illustrated in FIG. 15.

FIG. 18 illustrates a perspective view of the base illustrated in FIG. 16A-16D .

FIG. 19 illustrates a perspective view of a system, according to one example of the presently disclosed subject matter, comprising the base illustrated in FIG. 15 and the track, moving mechanism and cargo carrying member illustrated in FIGS. 9A and 9B.

FIG. 20A illustrates a perspective view of another example of a system according to the presently disclosed subject matter, wherein a cargo carrying member is in an extended position thereof.

FIG. 20B illustrates a perspective view of the system illustrated in FIG. 20A, wherein the cargo carrying member is in the retraced position thereof.

FIGS. 21A and 21B illustrate a perspective view of another example of a system according to the presently disclosed subject matter, wherein a cargo carrying member is respectively in the extended and retracted position thereof.

FIG. 22 illustrates a side view of another example of a system according to the presently disclosed subject matter, wherein a cargo carrying member is in a maximally extended position thereof at an exterior track distal end, with a cargo fixing apparatus in an initial state thereof.

FIGS. 23A and 23B illustrate side and front views, respectively, of the system illustrated in FIG. 22, wherein the cargo carrying member is in a maximally retracted position thereof and an interior track component is in an inclined orientation thereof.

FIGS. 24A and 24B illustrate side and front views, respectively, of the system illustrated in FIG. 22, wherein the cargo carrying member is in the maximally retracted position thereof and the interior track component is in a planar orientation thereof.

FIG. 25 illustrates a perspective view of the system illustrated in FIG. 22 in a storage state thereof, with an exemplary cargo loaded on the cargo carrying member.

### DETAILED DESCRIPTION OF EMBODIMENTS

A system according to the presently disclosed subject matter, and particularly, of any of the examples presented below, is operable for introducing cargo into and removing it from a seat of a passenger compartment of a vehicle, such as a car, from the ground or the like through a door frame of a corresponding vehicle side door, while using existing safety element/s of the vehicle associated with the seat configured for fastening a passenger, at least indirectly, to the seat.

Such safety elements of the vehicle associated with the seat can include seatbelts, and/or anchorage points that are part of a standardized system for facilitating secure installation of child car safety seats, such as the ISOFIX system. Using such safety elements allows the system to be installed in a vehicle and used without requiring any modifications to the vehicle.

A system according to the presently disclosed subject matter can comprise a base mountable to a seat of a passenger compartment of a vehicle, which can be in the form of a unitary body or an assembly of a number of components, or it can be constituted by a member of the system having a function additional to serving as a base. For example, such member can be a portion of a track. The base can have at least one connection element operable to detachably and securely attach the base to at least one of the safety elements of the vehicle. The at least one connection element can be in the form of any appropriate element for secure and detachable connection to the at least one safety element of the vehicle, for example, at least one slot shaped for a seatbelt to be threaded therethrough, or at least one ISOFIX connector operable to detachably attach to at least one ISOFIX anchorage point. In some embodiments of the presently disclosed subject matter, the base can comprise multiple forms of connection elements, each operable of attaching to a different of safety element of the vehicle. Such a multiple-capability connection can provide a reinforced connection between the base and the vehicle, thus enhancing the safety of the system.

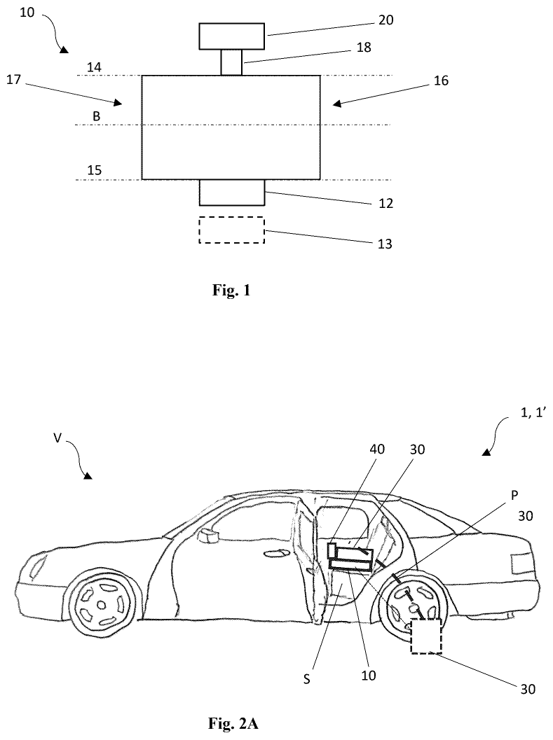

FIG. 1 schematically illustrates a plan view of one example of a base 10 that can be used in a system according to the presently disclosed subject matter. The base comprises a connection element 12 in the form of an ISOFIX connector which is operable to detachably and securely attach to an ISOFIX anchorage point 13 of a vehicle, shown in dashed lines.

A base according to the presently disclosed subject matter can have a base longitudinal axis, a seat facing surface, and a cargo facing surface. The base can be mountable on a rear seat having a seat longitudinal axis such that the base longitudinal axis is parallel to or coincident with the seat longitudinal axis, the seat facing surface faces towards the seat, and the cargo facing surface faces away from the seat. The base can comprise inboard and outboard side boundaries that define therebetween a length of the base along the base longitudinal axis. The base can further have front and rear portions respectively adjacent to front and rear boundaries of the base, which define therebetween a width of the base that extends at least partially along the depth of the seat, when the base is secured to the seat. The width of the base can be equal to, smaller than or greater than the depth of the seat. In the latter case, the front portion of the base when mounted to the seat, extends beyond a frontmost end of the seat.

The at least one connection element of the base can form a unitary body with the base or be securely fixed thereto. The at least one connection element can be at least partially disposed within the base or can protrude at least partially therefrom, e.g., from the rear boundary of the base. For example, the at least one connection element can be assembled with base at the rear portion thereof so as to project rearwardly from the rear boundary of the base. In some examples, the at least one connection element can comprise two connection elements spaced along the base longitudinal axis to the same distance as that between corresponding two safety elements of the seat.

The system can further comprise at least one front support leg for providing load-bearing support for the base at its front end, adjacent the front boundary of the base. The front support leg/s can be connected to the base at its upper end in any appropriate manner allowing a lower end of the leg/s to abut the floor of the car in front of the rear seat. The front support leg can have an adjustable height. In some examples, the front support leg can constitute a lower part of a front support member of the system, whose upper part can fulfill a function other than supporting the base, e.g., it can be a part of safety measures of the system as described in more detail below. In any case, the base can have a front support member/leg connection area located at a front end thereof, for connecting thereto the front support member/leg. The connection can be in the form of any suitable connection means such as screws, bolts, etc., or the connection area can be configured to receive therein the upper end of the leg or an intermediate portion the front support member. For example, such connection area can be comprise a port.

In the present example shown in FIG. 1, the base 10 has a base longitudinal axis B, front and rear boundaries 14 and 15, and outboard and inboard side boundaries 16 and 17. The connection element 12 constituted by an ISOFIX connector that projects rearwardly from the rear boundary 15 of the base, and a support leg receiving port 18 is located adjacent the front boundary 14, for engaging a front support member 20. The base comprises a cargo facing surface 19a and a seat facing surface (not seen).

A system according to the presently disclosed subject matter can be compatible with different types of heavy cargo, which dimensions allow it to be introduced into a passenger compartment of a vehicle. The cargo can be, for example, a suitcase or a box, or a mobility device such as a foldable wheelchair, walker or rollator. The system can be particularly helpful for old or disabled people who require use of such mobility devices and/or have trouble lifting heavy loads. Furthermore, the system can be installed in the rear passenger compartment of a vehicle. Storing and accessing cargo in the rear passenger compartment offers the benefit of a shorter walking distance from the front passenger compartment compared to the trunk, making it more convenient for a user sitting up front, especially for those who have trouble walking, such as those for whom the cargo is a mobility device. A system according to the presently disclosed subject matter can further comprise, at least in use, a moving mechanism for moving the cargo at least indirectly from its location outward the vehicle adjacent thereto onto the seat of the passenger compartment of the vehicle. The moving mechanism can have a cargo engaging portion configured to be securely attached to the cargo for moving thereof along a predetermined path. Alternatively, the system can further comprise a cargo carrying member moveable with respect to the base, and the moving mechanism can be operable to move the cargo carrying member along at least a majority of a pre-determined path between a retracted position in which the cargo carrying member at least partially overlies the cargo facing surface of the base, and an extended position in which the cargo carrying member is spaced from the cargo facing surface of the base, at least along the longitudinal axis of the base as seen at least in the plan view of the system,

to allow the cargo carrying member to be moved out of the vehicle via a door frame and vice versa. When in the extended position, the cargo carrying member can securely engage the cargo, such that when the moving mechanism brings the cargo carrying member to the retracted position, the cargo is brought into the vehicle as well.

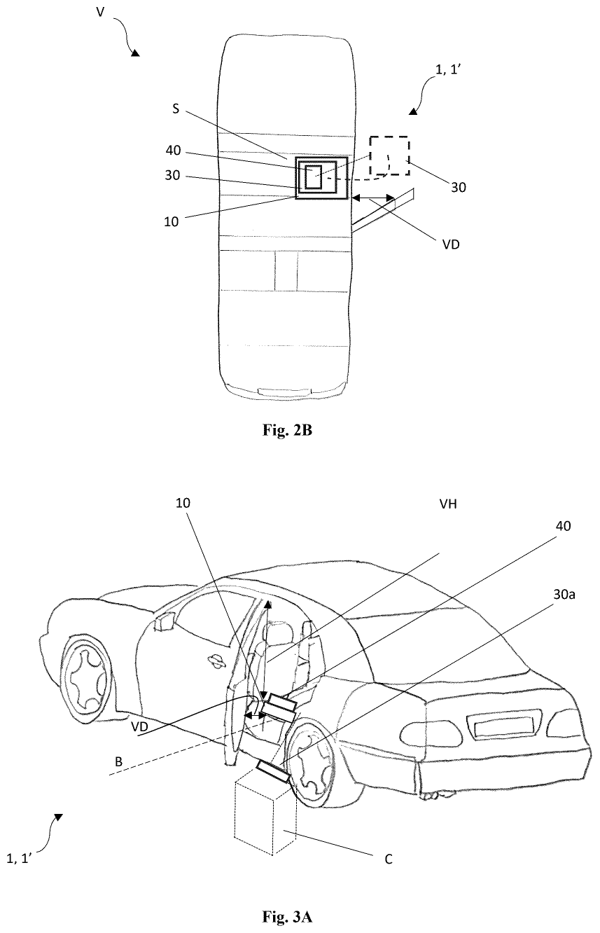

The moving mechanism can be mounted at least partially and/or at least indirectly to the base and/or to the cargo carrying member, and it can be configured for being operated manually or automatically, or by a combination thereof. FIGS. 2A and 2B schematically illustrate, respectively, an elevation view and a plan view of a vehicle V with a rear seat S and a system 1 according to an example of the presently disclosed subject matter, comprising the base 10 connected to the rear seat S of a vehicle V by at least one ISOFIX safety element (not seen). The system 1 further comprises a cargo carrying member 30 and a moving mechanism 40 mounted to the base 10 and is operable to move the cargo carrying member 30 along a path P between the extended and retracted positions thereof.

The moving mechanism can be external to or at least partially integrally formed with the cargo carrying member. For example, the moving mechanism can be constituted by a crane lift having a retractable cable, and the cargo carrying member can be attached to the outermost end of the cable. Alternatively, the moving mechanism can be constituted by a miniature boom lift comprising a boom arm having a proximal end fixedly connected to the base, and a distal end on which a cargo carrying member is mounted. Further alternatively, the system can comprise a track which can define at least a part of the above-mentioned path, and the moving mechanism can be operable to move the cargo carrying member along the track, comprising a motorized system having components disposed on or attached to the cargo carrying member. In each of the above examples, the cargo carrying member can be constituted by any appropriate means for securely engaging cargo, for example a gripper in the form of a platform, a clamp, straps, or a combination thereof. In a case when the system comprises a track, the cargo carrying member can further comprise track engaging elements such as wheels, or anti-tip rotatable pins to engage the track.

The path along which the cargo carrying member is moveable between the extended and retracted positions thereof, is subject to a constraint relating to doors of passenger compartments of vehicles such as cars. As car doors typically open maximally to an acute angle relative to the door frame, the space between the outboard end of the seat and the inner surface of the open car door imposes a constraint on the path. This constraint can be characterized by the shortest distance between the open car door and the outboard end of the seat is a direction parallel to the longitudinal axis of the seat.

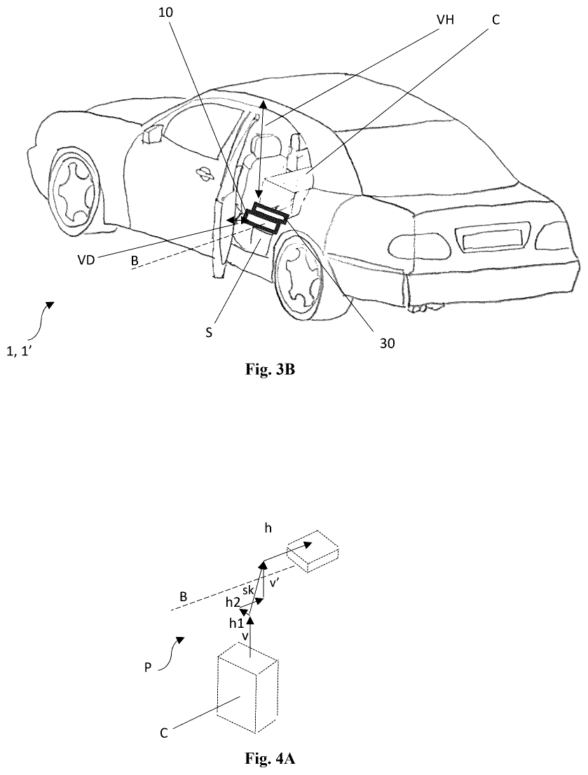

FIGS. 3A and 3B schematically illustrate perspective views of the system 1 mounted to the rear seat S of a car V. They depict the cargo carrying member 30 in the extended and retracted positions, respectively, with cargo C attached to it (shown in dashed lines), as well as corresponding constraints. The distance between the surface of the seat and the upper portion of the door frame is labelled VH and the shortest distance between the open car door and the outboard end of the seat which distance is parallel to the longitudinal axis of the seat is labelled VD (best seen in FIG. 2B).

In view of the constraints described with reference to FIGS. 3A and 3B, the prescribed path along which a cargo or a cargo carrying member can be moveable using a system according to the presently disclosed subject matter, can include at least one angled vector component oriented at an angle relative to the base longitudinal axis, at least in the plan view of the system. More particularly, the cargo facing surface of the base can define a plane and the projection of the at least one angled vector components onto the plane can be oriented at an angle relative to the projection of the base longitudinal axis onto the plane. When referring to the projection onto a plane, this also encompasses cases where the axis lies within the plane itself. The at least one angled vector component can be constituted by a respective askew vector component oriented askew to the base longitudinal axis. Such an angled or askew vector component can allow the cargo to be brought through the space limited by the distance VD (best seen in FIG. 2B) between the outboard end of the rear seat and the open door of the vehicle.

The path can be continuously curved at least along a majority thereof or can have a number of curved and/or straight segments. In some examples, the path can have a distal path portion associated with a maximally remote position of the cargo or maximally extended position of the cargo carrying member, and a proximal path portion associated with a maximally retracted position of the cargo/cargo carrying member.

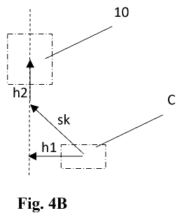

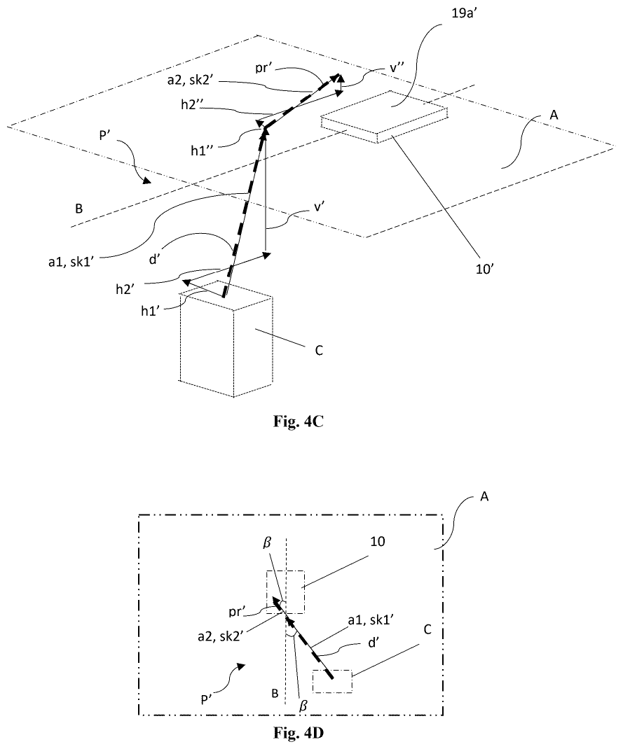

In some examples of the presently disclosed subject matter, the path can further comprise an intermediate path portion between the distal and proximal path portions, and the intermediate path portion can comprise the at least one askew vector component. More particularly, the distal path portion and the intermediate path portion can include together, in addition to the askew vector component, at least one vertical and at least one horizontal vector component to bring cargo from the ground to at least the height of the seat, and the proximal path portion can include a single horizontal vector component to move the cargo along the seat of the passenger compartment. FIGS. 4A and 4B schematically illustrate, in respective perspective and plan views, one example of a path which the cargo carrying member 30 of the system 1 of the present example, can be moved along to meet the constraints described above with reference to FIGS. 3A and 3B. The illustrated exemplary path P comprises a vertical distal path portion defined by a vector v, a horizontal proximal path portion defined by a vector h and an intermediate path portion defined by vectors sk, v′, h′ and h″, the vector sk being askew to the base longitudinal axis B in the plan view of FIG. 4B. As can also be seen in FIG. 4B, the distal and proximal path portions are spaced from each other by the intermediate path portion in a direction perpendicular to the longitudinal base axis.

In other examples of the presently disclosed subject matter, the path can comprise a distal path portion associated with a maximally remote position of the cargo or maximally extended position of the cargo carrying member, and a proximal path portion associated with a maximally retracted position of the cargo or cargo carrying member. The distal path portion can include at least one vertical vector component to bring cargo from the ground to at least the height of the seat, and a horizontal vector component to bring the cargo towards the base. The proximal path portion can include at least one horizontal vector component to move the cargo along the seat of the passenger compartment. Each or at least one of the proximal and distal path portions can include one of the aforementioned angled vector components. One or each of these angled vector components can be constituted by an askew vector component that is askew to the base longitudinal axis.

Reference will now be made to another system according to the presently disclosed subject matter, designated as 1′. The system 1′ corresponds to the system 1 and its constraints as described in FIGS. 2A-3B , with reference numerals for corresponding features distinguished by an apostrophe.

FIGS. 4C and 4D schematically illustrate, in respective perspective and plan views, another schematic example of an exemplary path P′, shown in dashed lines, which a cargo carrying member of the system 1′ can be moved along to meet the constraints described above with reference to FIGS. 3A and 3B. The path P′ comprises a distal path portion d′, associated with a maximally extended position of the cargo carrying member, and a proximal path portion pr′, associated with a maximally retracted position of the cargo carrying member in which the cargo carrying member overlies at least partially the cargo facing surface 19a′ of the base 10′. The base longitudinal axis B′ of the base 10′ is disposed below the cargo facing surface 19a′ and above the seat facing surface (not seen) thereof. The cargo facing surface 19a′ of the base lies in and defines a plane designated A′.

The distal and proximal path portions d′ and pr′ each comprise an angled vector component designated a1 and a2 respectively. As shown in FIG. 4D, a projection of each angled vector component a1, a2 onto the plane A is oriented at an angle β relative to the projection of the base longitudinal axis B onto the plane A.

As seen in FIG. 4C, the angled vector components a1 and a2 are each constituted by an askew vector component, respectively designated sk1′ and sk2′ oriented askew to the base longitudinal axis B′. The askew vector component sk1′ of the distal path portion d′ comprises first and second horizontal vector components h1′ and h2′, and a vertical vector component v′. The vertical vector component v′ is greater than each of the horizontal vector components h1′, h2′. The askew vector sk2′ of the proximal path portion pr′ comprises vector components h1″, h2″ and v″. In some embodiments of the presently disclosed subject matter, the moving mechanism can be operable to move a cargo carrying member along a portion of the prescribed path providing only a part of the vector components of the path, and in other embodiments the moving mechanism can move the cargo carrying member along the entire path providing all of them. For example, in a path which comprises a proximal, a distal and an intermediate path portion, the moving mechanism can be operable to move the cargo carrying member along only the proximal and distal portions of the path, and manual adjustment of the cargo carrying member is required to provide the remaining vector component or components of the intermediate path portion. Thus, when the moving mechanism and cargo carrying member are constituted by a crane, the crane can be operable to lift the cargo carrying member, along with the cargo, in the vertical direction, and the cargo carrying member can be manually moved along the horizontal and askew vector components in the path.

In some examples of the presently disclosed subject matter, the system can have an operational state in which it is operable for introducing cargo onto, and removing it from, a seat of a passenger compartment of a vehicle through a door frame of a corresponding vehicle side door, and a storage state in which said cargo carrying member with or without said cargo is located within said boundaries of said base.

At least when in the operational state, the system can comprise a track having a longitudinal central track axis that defines at least a portion of the path.

In some of such examples of the presently disclosed subject matter which comprise a track, the system may comprise a moving mechanism operable for moving cargo at least indirectly along the track using a cargo carrying member as described above or using any other appropriate means. The track can have a 3D structure with a central axis representing at least a portion of the path. The track can comprise any appropriate elements which a cargo carrying member may engage, for example a flat driving surface with side walls extending along the central axis, or two parallel rails on different sides of the central axis.

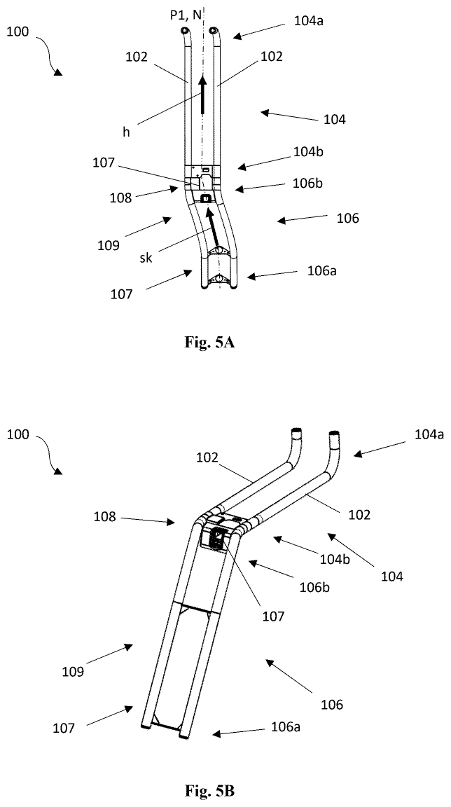

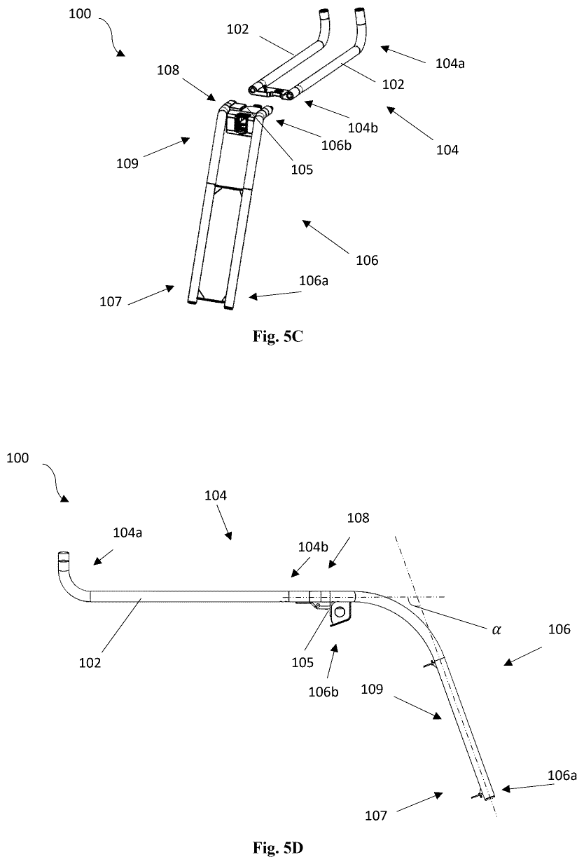

FIG. 5A illustrates a plan view of one example of a track 100 that can be used in a system according to the presently disclosed subject matter. The track 100 has a central axis N representing a path P1 having a horizontal vector component shown with arrow h which can be parallel to the base longitudinal axis when the track is mounted to the base, and an askew vector component shown with arrow sk that is askew relative to the base longitudinal axis. The track comprises two parallel rails 102 spaced apart about the central axis N.

FIG. 6A illustrates a plan view of another example of a track 100′ that can be used in a system according to the presently disclosed subject matter. The track 100′ has a track central axis N′ representing a path P1′. The path P1′ comprises two askew vector components shown with arrows sk1′ and sk2′ that are angled relative to the base longitudinal axis at least in a plan view of the track 100′ when the track is mounted to the base (not shown). The track comprises two parallel rails 102′ spaced apart about the track central axis N′. The path P1′ can correspond to the path illustrated in FIG. 4D. A track, according to the presently disclosed subject matter, can be constituted by a single unitary body, or by two or more connectable components. In some examples, the track can comprise two components that are detachably attachable to each other at respective end portions thereof. In other examples, the track can be constituted by two connected components, with a first component being extendable relative to a second component, for example in a telescopic manner.

The track may consist of an interior track component mountable, fixedly or adjustably to, or integrally formed with, the base of the system or at least its cargo facing surface, or constituting such base with its cargo facing surface, and an exterior track component connectable to the interior track component or extendable therefrom so as to extend outside of the vehicle through the vehicle door frame. The interior track component can thus extend along an interior portion of the track central axis, which in turn can represent the path proximal portion. Similarly, the exterior track component can extend along an exterior portion of the track central axis, which in turn represents path distal and intermediate portions.

The interior track component can be linear, whereby its corresponding interior portion of the track central axis lays in a plane parallel to or coincident with a plane defined by the cargo facing surface of the base. In some examples, the interior portion of the track central axis corresponding to the interior track portion is parallel to or coincident with, the base longitudinal axis at least along a portion thereof. The interior track component can have an interior track inboard end adjacent the inboard side boundary of the base and an interior track outboard end adjacent to the outboard side boundary of the base.

The exterior track component can have an exterior track proximal section with an exterior track proximal end, and an exterior track distal section with an exterior track distal end spaced from exterior track proximal end along the track central axis. At least when the track is in the operational state thereof, the exterior track proximal end can be adjacent to the interior track outboard end.

In some embodiments, the exterior track component can have a distal section with a distal end, and a proximal section with a proximal end that is detachably attachable to the interior track outboard end and spaced from the distal end by an intermediate section. In such embodiments, the sections of the exterior track components can be oriented relative to each other in different ways. For example, the proximal and intermediate sections of the exterior track component can be continuously curved and disposed in a horizontal plane, such that in the plan view of the track, when the proximal end of the exterior track component is connected to the outboard end of the interior track component, the proximal and intermediate sections of the exterior track component can continuously curve away from the interior track component. The distal component of the track can be oriented at a right angle to the intermediate section of the track in an elevation view of the track.

Alternatively, the distal and proximal sections of the exterior track components can be straight at least along a majority of their length and the exterior track distal section can be oriented transversely to the interior track component so that, when the latter component is oriented horizontally, the exterior track distal section forms an obtuse angle therewith in the front view of the track. The track distal section can also form an obtuse angle with the track proximal section. The intermediate section of the exterior track component can have a curved shape and can be oriented at least partially askew to the exterior track distal and proximal sections at least in a plan view of the track.

FIGS. 5B, 5C and 5D respectively illustrate perspective exploded and side views of the track 100 illustrated in FIG. 5A. The track 100 comprises an interior track component 104 having an inboard end 104a and an outboard end 104b and being straight along the entirety thereof. The track further comprises an exterior track component 106 having a distal portion with a distal end 106a and a proximal portion with a proximal end 106b. The proximal end 106b of the exterior track component 106 comprises a fixation member 105 operable to fixedly and detachably attach to the outboard end 104b of interior track component 104.

The exterior track component 106 has a distal section 107 comprising the distal end 106a thereof, and a proximal section 108 comprising the proximal end 106a thereof and an intermediate section 109 therebetween. As best seen in FIG. 5A, the intermediate section has a curved shape and is oriented askew to the exterior track distal and proximal sections in the plan view of the track. Additionally, the exterior track distal section 107 is oriented transversely to the interior track component 104. As best seen in FIG. 5D, the distal portion of the exterior track component forms an obtuse angle ∝ with the proximal portion of the exterior track component in the front view of the track.

In some embodiments of the presently disclosed subject matter, the track can be constituted by an interior track component and an exterior track component, wherein the exterior track component is movable between a storage position, when the system is in its storage state, and a deployed position, when the system is in its operational state. The exterior track component can be extendable from a stowed position constituting the storage position, in which the exterior track distal end is spaced from the interior track inboard end at a first distance, to the deployed position, wherein the exterior track distal end is spaced from the interior track inboard to a second distance greater than the first distance. The first distance can be zero or greater, allowing the exterior track distal end to retract until it aligns with or even extends beyond the interior track inboard end. When the exterior track component is in its stowed position, the exterior track proximal end can be adjacent to the interior track inboard end, and the exterior track distal end can be adjacent to the interior track outboard end. When in the deployed position thereof, the exterior track proximal end can be adjacent to the interior track outboard end. The exterior track component can be telescopically extendable from said interior track component.

FIGS. 6B and 6C illustrates perspective views of the track 100′ illustrated in FIG. 6A which comprises an interior track component designated 104′, and an exterior track component designated 106′. The exterior track component 106′ is telescopically extendable from the interior track

component 104′, between a stowed position, shown in FIG. 6B, when the system is in its storage state, and a deployed position, shown in FIG. 6C, when the system is in its operational state. In the stowed position of the exterior track component 106′, the exterior track distal end 106a′ is spaced from the interior track inboard end 104a′ at a first distance designated d1. The exterior track proximal end 106b′ is adjacent to the interior track inboard end 104a′, and the exterior track distal end 106a′ is adjacent to the interior track outboard end 104b′. In the deployed position of the exterior track component 106′, the exterior track distal end 106a′ is spaced from the interior track inboard end 104b′ to a second distance d2, which is greater than the first distance d1. The exterior track proximal end 106b′ is adjacent to the interior track outboard end 104b′.

The exterior track component can be configurable between a planar configuration and a spatial configuration. When in the stowed position, the exterior track component can be in a planar configuration, and when in the deployed position, the exterior track component can be in a spatial configuration. The exterior track component, at least when viewed from the front view, can appear linear in the planar configuration and curved in the spatial configuration. In the deployed state of the track, an obtuse angle can exist between a part of the exterior portion of the axis along which the exterior track proximal section extends and a part of the axis along which the exterior track distal section extends, at least in the front view of the track.

The exterior track component may comprise any appropriate means necessary to allow it to transition between its planar and curved orientations, while maintaining the rigidity required in the curved orientation to support the weight of the cargo carrying member and its cargo. For example, the exterior track component may include rigid pieces connected by joints that allow slight rotation, enabling the pieces to move from a parallel arrangement to a predetermined curved shape. Alternatively, it may comprise a flexible structure with integrated reinforcements that provide stability when curved. Additionally, when the track is in the deployed position, the exterior track proximal section can be aligned with the outboard end of the interior track component.

FIGS. 6D and 6E illustrate the track illustrated in FIGS. 6A-6C , when viewed in the front view, wherein the exterior track component 106′ is in its stowed and deployed positions, respectively. When in the stowed position, the exterior track component 106′ is in a planar configuration. As seen in FIG. 6D, the exterior track component 106′ appears linear when in the planar configuration. When in the deployed position of the track 100′, the exterior track component 106′ is in a spatial configuration. As seen in FIG. 6E, the exterior track component 106′ is curved when in the spatial configuration. In particular, an obtuse angle ∝′ exists between a part of the exterior portion N1′ of the axis N′ along which the exterior track proximal section 106p′ extends and a part of the axis along which the exterior track distal section 106d′ extends, designated N2′. The axis portions N1′ and N2′ have been extended in FIG. 6E to intersect in order to show the angle ∝′ therebetween. The exterior track proximal section 106p′ is aligned with the interior track outboard end 104b′ of the interior track component 104′.

An exterior track component, according to at least some examples of the presently disclosed subject matter, can be extendable to enable the distal end of the exterior track component to reach the ground, thereby permitting the use of the system with vehicles having seats of different heights above the ground.

In other examples of the presently disclosed subject matter, the system can comprise a ground support member connected to the exterior track distal portion of the exterior track component and extendable therefrom downwardly, from a retracted position thereof to a deployed position thereof, to engage a surface from which the cargo is to be raised. The ground support member can have an adjustable length, thereby permitting the use of the system with vehicles having seats of different heights above the ground. The ground support member may comprise any appropriate mechanism or mechanisms of extension, for example, telescopic extension, folding about a hinge, pivoting about a pivot axis, or both telescopic extension and pivoting about a pivot axis. The exterior track component can have a cover piece mounted thereto to prevent objects external from the system from interfering with the ground support member.

In some examples of the presently disclosed subject matter, the ground support member can be in the form of an extension leg. The extension leg can be constituted by a slidable shaft having a floor engaging piece at a distal end thereof.

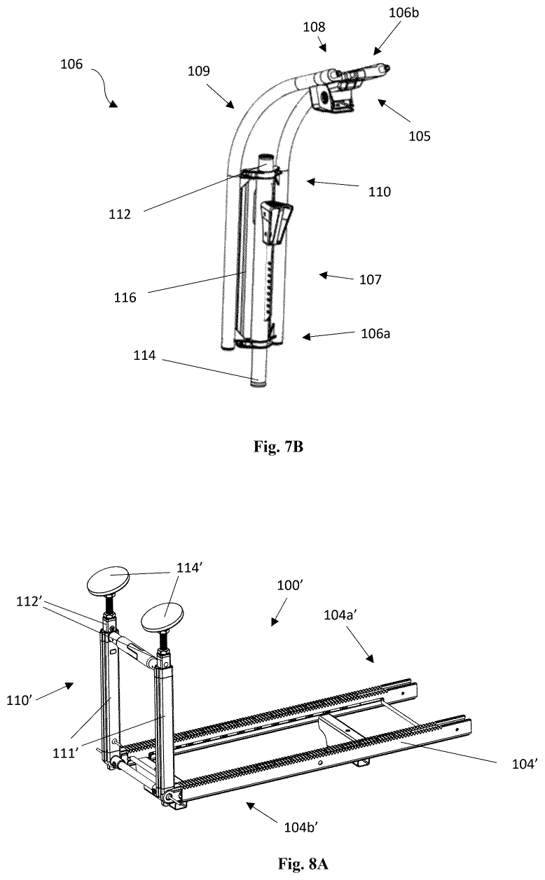

FIGS. 7A and 7B illustrate perspective side views of the exterior track component 106 of FIGS. 5A-5C, further comprising an extension leg designated 110, when the extension leg 110 is respectively in the retracted and deployed positions thereof. The extension leg 110 is constituted by a slidable shaft 112 having a ground engaging piece 114 at the distal end thereof. The exterior track component 106 comprises a cover piece 116 mounted to the rails 102 thereof.

In further examples of a system according to the present disclosure, the ground support member may be movably connected to the distal end of the exterior track portion, allowing it to transition between retracted and deployed positions. In certain examples, the movable connection may be a pivoting mechanism. In other examples, the ground support member may be detachably attachable to the distal end of the exterior track portion.

When the exterior track component is in its storage position, the ground support member can be moved, for example by pivoting, to extend upward in its retracted position. In the retracted position, the ground support member can constitute an outboard side safety barrier, which can prevent cargo, brought into a vehicle using the system and stored on the base, from moving off the base in the direction of the outboard end of the base. Such a safety barrier is particularly advantageous in the event of a vehicular accident, or during bumpy ride conditions.

When the exterior track component is in its deployed position, the ground support member can be moved, for example by pivoting, to extend downwards from the exterior track distal portion. Such a ground support member can comprise a ground support locking mechanism operable to prevent movement of the ground support member with respect to the exterior track distal end. The ground support member locking mechanism can be any appropriate type, for example, a ratcheting system, a pin-and-hole arrangement, or a cam-lock system. In another example, the ground support member locking mechanism may comprise a spring-loaded mechanism. The ground support member can further comprise at least one ground engaging piece at a distal end thereof configured to contact the surface from which the cargo is to be raised. In some examples, the ground support member can comprise two ground engaging pieces at a distal end thereof. The ground support member can further be extendable, for example, telescopically or slidably adjustable, to accommodate varying vehicle heights relative to the surface from which the cargo is to be raised.

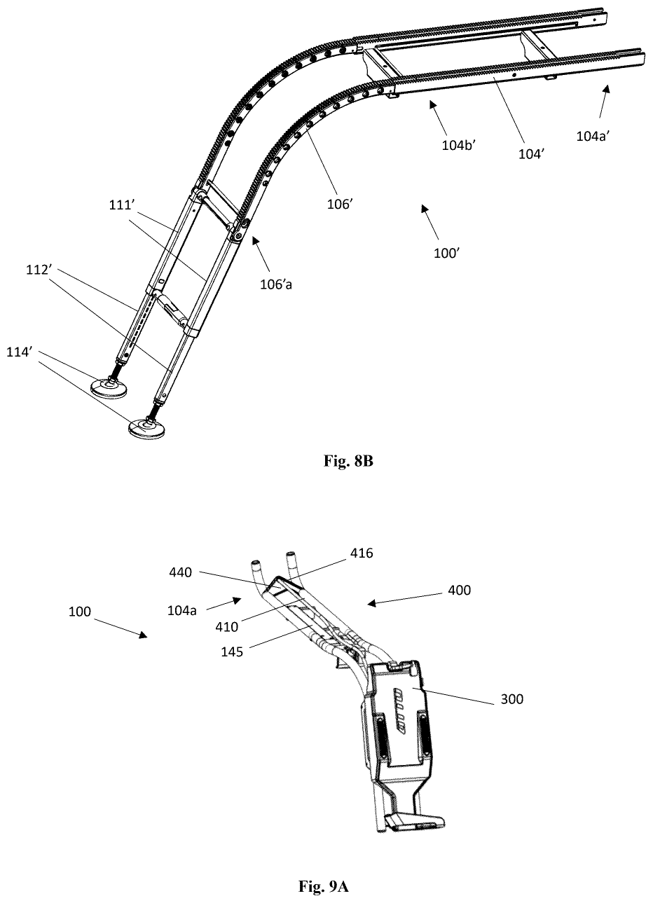

FIGS. 8A and 8B illustrate perspective views of the track 100′ illustrated in FIGS. 6A-6E , further comprising a ground support member, designated 110′, in the retracted and deployed positions thereof. The ground support member 110′ is constituted by two parallel rails 111′, each comprising a shaft 112′ telescopically extendable therefrom and having a ground engaging piece 114′ at the distal end 112a′ thereof. The ground support member 110′ is pivotably connected to the distal end 106a′ of the exterior track portion 106′, so as to be pivotable between its retracted position, shown in FIG. 8A, and its deployed position, shown in FIG. 8B. In the deployed position, the shafts 112′ extend from the exterior track distal portion 106a′. In the retracted position the shafts 112′ are telescopically retracted into the parallel rails 111′. A telescopic track of the type described above can further include a safety locking system to ensure that the exterior track component remains in its extended position unless intentionally released. The safety locking system can include any appropriate locking means, for example, a spring-loaded latch, a pin-and-slot mechanism, or a magnetic locking device. In some embodiments, the locking system could also incorporate an electromechanical release, such as a solenoid, for controlled disengagement.

In some examples, the safety locking system can include at least one spring-loaded locking mechanism located at the exterior track's proximal end and a cable can be connected to the spring-loaded locking mechanism and can run to the exterior track's distal portion. This cable can be accessible, at least indirectly, from the exterior track's distal end and moved to release the spring-loaded locking mechanism.

When a ground support member is pivotably attached to such a track having such a safety locking system, and the ground support member further comprises a ground support member locking mechanism, the safety locking system and the ground support member locking mechanism can be interconnected. Such interconnection can allow quicker, more efficient movement of the system between its operational and storage states, offering greater convenience and ease of use for a user. For example, in the example wherein the safety locking system and ground support member locking mechanism are constituted by the above-described spring-loaded mechanisms and cable, the cable can be attached to the spring-loaded locking member of the ground support member locking mechanism, thus linking the locking of the exterior track component and the ground support member. In this configuration, releasing the spring-loaded mechanism of the ground support member can also move the cable, thereby releasing the spring-loaded locking mechanism of the track.

It should be understood that the track described above can be used in any system according to the presently disclosed subject matter or any other system in which cargo should be moved from the ground or the like into a vehicle compartment through an open door thereof. The same applies for the exterior track component described above.

In some examples of a system according to the presently disclosed subject matter which comprises a track, the moving mechanism can comprise a hoist system operable to move cargo, at least indirectly, along at least a part of the track. The hoist system can be manual, or motorized, or partially manual and partially motorized. For example, the hoist system can be constituted by a motorized hoist system. The system can further comprise a cargo carrying member, and the motorized hoist system can move the cargo carrying member along the track at least from the extended position to the retracted position thereof. The motorized hoist system can comprise at least one cable having a spool end and an anchorable end, at least one spool on which the corresponding cable is windable and to which the spool end of the cable is fixedly connected, at least one anchoring member to which the corresponding anchored end of the cable is fixedly connected, and a motor operable to rotate the at least one spool and thereby cause the cable to change its length between the spool and the anchorable ends thereof. The at least one spool and motor can be mounted at least indirectly to the base, and the anchoring member can be disposed in the cargo carrying member. Alternatively, the at least one spool and motor can be disposed in the cargo carrying member, and the anchoring member can be mounted at least indirectly to the base.

In embodiments in which the moving mechanism comprises a cable, the cable is operable to transmit tensile forces and thereby pull the cargo carrying member along the track toward the base. Accordingly, movement of the cargo carrying member in a direction away from the base, for example downwardly along the exterior track component from the interior track component toward the ground, may, at least along a portion of the path, occur under the influence of gravity. In such embodiments, the cable, spool, and motor assembly may be operable to control the rate at which the cable unwinds so as to resist and regulate gravitational descent of the cargo carrying member along the track, thereby stabilizing and slowing its movement.

FIGS. 9A and 9B illustrate opposite perspective views of the track 100 illustrated in FIGS. 5A-5C with a moving mechanism 400 and cargo carrying member 300 mounted thereon. As seen in FIG. 9A, the moving mechanism 400 comprises a cable 410 having a spool end 412 and an anchorable end 416, a spool 420 on which the cable 410 is windable and the spool end 412 is fixedly connected, a motor 430, and an anchoring member 440 to which the corresponding anchorable end 416 of the cable 410 is fixedly connected. The spool 420 and motor 430 are mounted on the cargo carrying member 300, and the anchoring member 440 is mounted to the interior track component 104, adjacent the inboard end 104a. The motor 430 is operable to rotate the spool 420 to which the spool end 412 of the cable 410 is fixedly connected, thereby winding the cable 410 and pulling the cargo carrying member 300 towards the anchoring member 440.

Such a motorized hoist system can move the cargo carrying member along a track from the extended position to the retracted position and vice versa but, if desired, manual assistance can be used or added to facilitate the movement of the cargo carrying member from the retracted position to the extended position. The system and moving mechanism may include an additional means to move the cargo carrying member from the retracted position to the extended position.

For example, the system may include a secondary hoist system similar to the hoist system described heretofore but having its anchoring member disposed on the distal end of the exterior track component, and being operable only to move the cargo carrying member from the retracted position to the extended position thereof. Alternatively, the system can further comprise a pushing member operable to move along the interior track component and push the cargo carrying member along with it. In this case, upon reaching the outboard end of the interior track component, the cargo carrying member can move under the influence of gravity along the exterior track component.

Further alternatively, in some examples of the presently disclosed subject matter, the system can further comprise a driving surface, and the moving member or cargo carrying member can comprise at least one wheel, rotatable by a motor to roll without slipping on the driving surface. The motor can be the same motor described earlier with respect to the motorized hoist system, and the wheel can be constituted by the spool. The spool can have an outer surface having a high friction coefficient particularly suitable for functioning as a wheel. Thus, when moving from the retracted position to the extended position, the cargo carrying member can drive along the driving surface, and when moving from the extended position to the retracted position the motorized hoist can pull the cargo carrying member.

In some examples of the system wherein the system comprises an interior and an exterior track component and the moving mechanism described above with reference to FIGS. 9A and 9B, the driving surface can extend along at least a section of the interior track component. Upon reaching the end of the driving surface at the outboard end of the interior track component, the cargo carrying member can move along the exterior track component under the influence of gravity. As the cargo carrying member moves along the exterior track component, the spool can provide resistance to gravity as the cable unwinds around it. The resistance can regulate the descent of the cargo carrying member.

Referring again to FIGS. 9A and 9B, the track 100 further comprises a driving track 145 (seen in FIGS. 9A and 15) mounted to the interior track component 104. The spool 420 has an outer surface 422, and the motor 430 is operable to rotate the spool 420 which acts as a wheel drivable along the driving track 145.

In accordance with the presently disclosed subject matter, a cargo carrying member can have at least one track engaging element for slidingly engaging a track. An appropriate track engaging element may be selected based on the construction of the track. For example, if the track is constituted by a flat driving surface, the track engaging elements may be constituted by four wheels configured to roll therealong. For safety measures such a track can additionally comprise side walls, to prevent the cargo carrying member from deviating off of the driving surface. Alternatively, if the track is constituted by two parallel rails, the track engaging elements may be constituted by a wheel, or an anti-tipping roller. In order to securely engage the track, the at least one track element can be constituted by at least two track elements constituting a track element pair, arranged to fit a section of track between them. Such a pair can allow the track engaging element to remain secured to the track while slidingly engaging the track.

FIG. 10 illustrates a back perspective view of the cargo carrying member 300 illustrated in FIGS. 9A and 9B with the spool 420 and motor 430 of the moving mechanism mounted therein. The cargo carrying member 300 comprises four pairs 310 of track engaging elements 312 disposed on the cargo carrying member, each pair being oriented to fit a rail therebetween.

In some examples of a system according to the disclosed subject matter, which include a track as described in at least one of the previous examples, the track may include at least one rail portion extending parallel to or coincident with the track central axis. In some examples where the track comprises an interior and an exterior track component, each of these track components can include at least one rail portions. The cargo carrying member can comprise at least one track-engaging element, for example a wheel or roller, designed to slidingly engage the at least one rail. In some examples, the at least one track-engaging element can be constituted at least by one or more pairs of wheels.

The moving mechanism in such exemplary systems can comprise, for example, a rack-and-pinion mechanism. The rack-and-pinion mechanism can comprise a rack disposed on each of the rail portions, and at least one corresponding pinion and a motor disposed on the cargo carrying member. The motor can be operable to rotate the at least one pinion along the racks. These racks can extend either along the entire length of the track or along specific portions. In embodiments of a system comprising a track having two rails, the at least one pinion mechanism may be constituted by two pinions, each designed to engage one of the two rails.

FIG. 11 illustrates a perspective view of part of the system 1′ comprising the track 100′ illustrated in FIGS. 6A to 6E, with one example of a cargo carrying member, designated 300′, in the extended position thereof. FIG. 12 illustrates a perspective view of a portion of the cargo carrying member 300′ shown in FIG. 11.

The track 100′ comprises two parallel rails 102′, spaced apart about and extending along the track central axis N′, representing the path P1′. The cargo carrying member 300′ comprises two pairs of track engaging elements 312′ disposed thereon, each pair being oriented to fit a rail 102′ therebetween. The moving mechanism 400′ is constituted by a rack-and-pinion system, with a rack 401 disposed on each of the rail portions 102′. The moving mechanism 400′ further comprises a motor 402 and two pinions 403, both of which are positioned on the cargo carrying member 300′. Two additional track engaging elements 312′ are disposed on the cargo carrying member 300′, each opposite to one of the pinions 403, to slidingly engage a lower surface of the rail 102′. The motor 402 is operable to rotate the pinion 403 along the racks 401, so as to move the cargo carrying member 300′ along the rail portions 102′ of the track 100′. The track-engaging elements 312′ consist of rolling pins that can passively roll along the rails, ensuring the cargo carrying member 300′ remains securely engaged with the rails 102′ while facilitating smooth and efficient movement along the track.

A cargo carrying member, according to the presently disclosed subject matter, can comprise a track facing surface which faces the track along the entire movement of the member, and a cargo fixing apparatus that is operable to fixedly receive cargo. The cargo fixing apparatus can maintain a constant orientation with respect to the track facing surface during movement of the cargo carrying member between the extended and retracted positions of the cargo carrying member. The cargo fixing apparatus can be at least indirectly connected to the at least one track engaging element so as to be moveable thereby along said path.

The cargo fixing unit can comprise a bottom support surface that is operable to contact a first surface of the cargo, and a side support surface operable to contact a second surface of the cargo, at least when the cargo carrying member, with the cargo, is moved along said path.

In the case that the cargo has a wheel, the cargo can be rolled onto the bottom support surface, which will engage the wheel. The cargo supporting unit can be manipulable between an initial state, in which the bottom support surface is oriented horizontally facilitating cargo loading thereon, enabling it to bear at least most of the cargo weight, and is angled relative to the track facing surface at a first angle, and an inclined state in which the bottom surface is inclined at a second angle relative to the track facing surface. In the initial state, the bottom surface can bear at least most of the cargo weight, and in the inclined state at least part of the cargo weight can be borne by the side support surface. When in use, the cargo support unit may be moved to its inclined state in order to align with the inclination of the exterior track component.

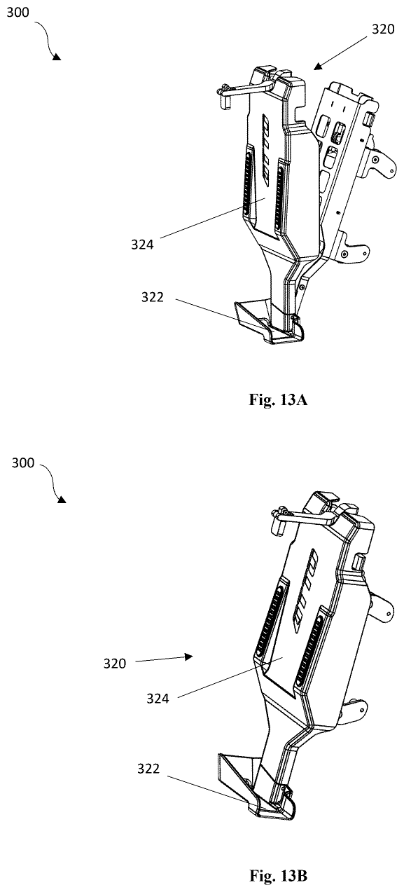

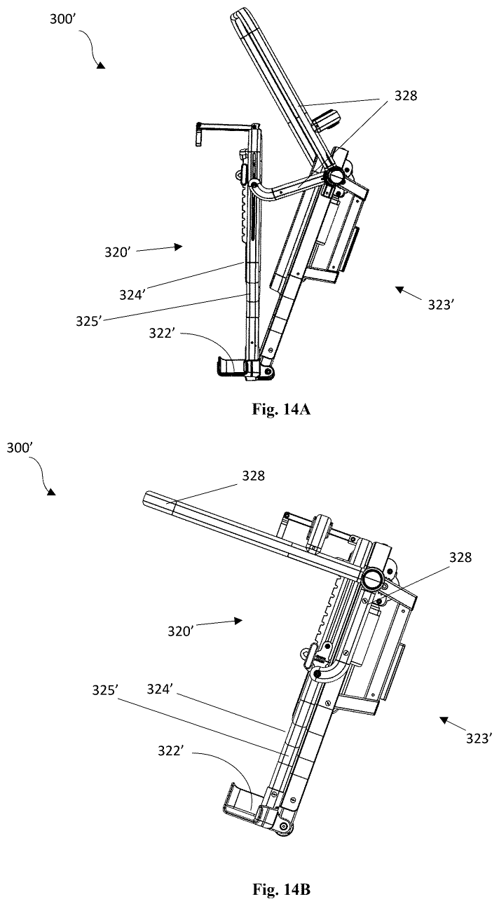

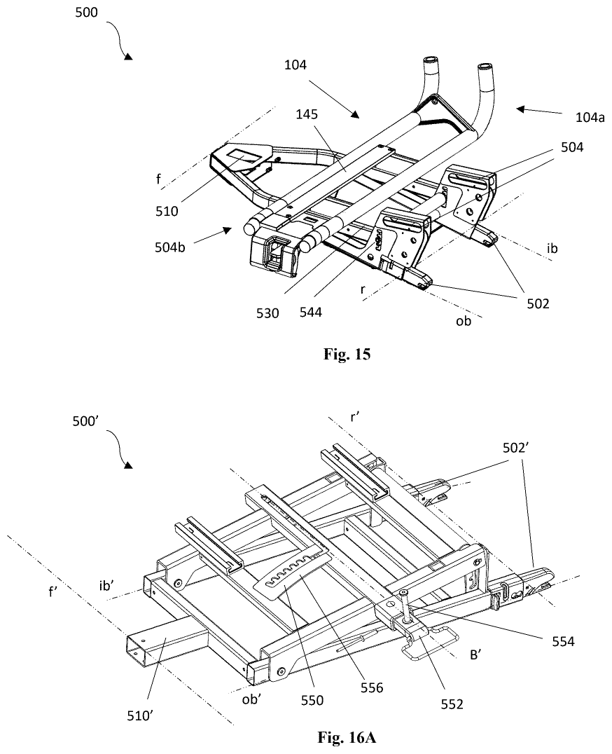

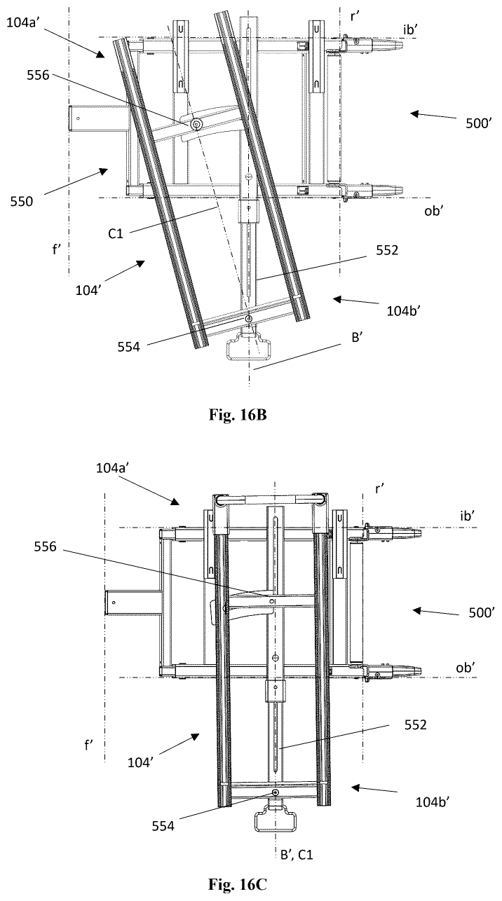

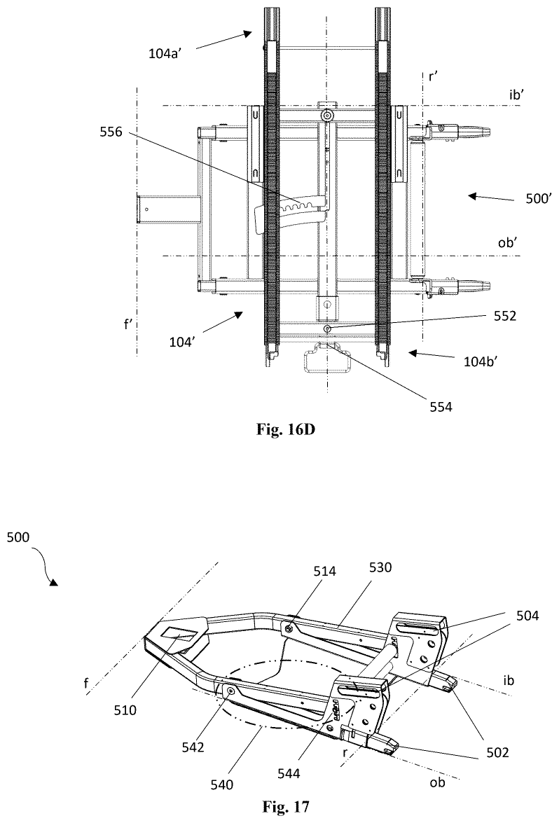

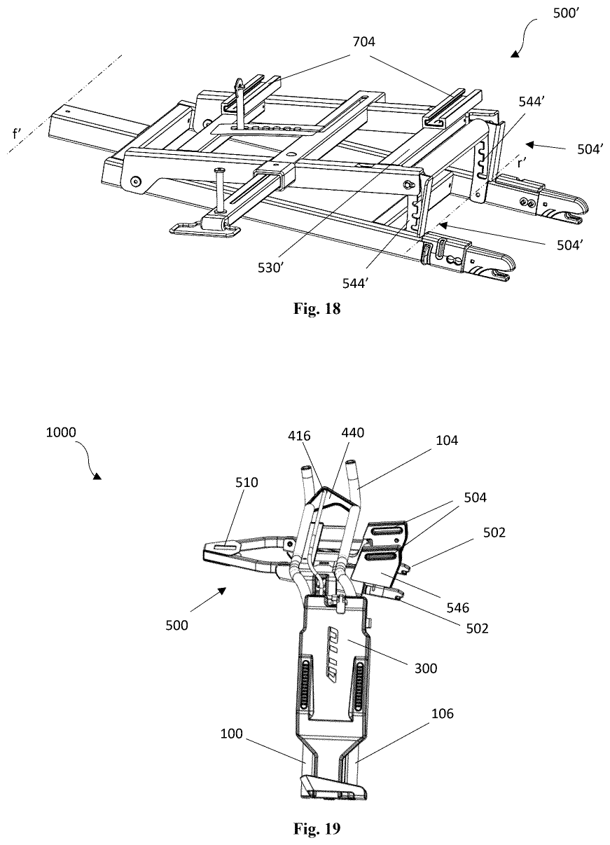

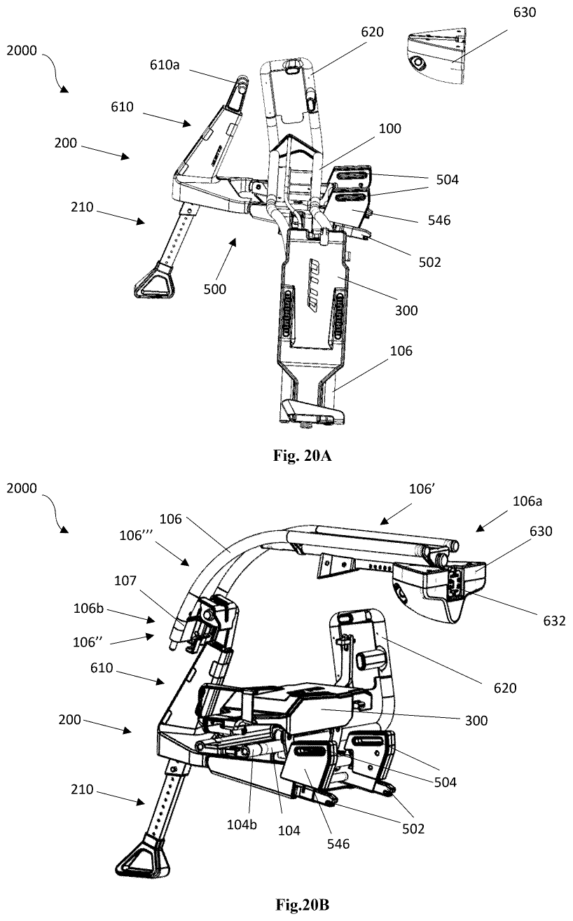

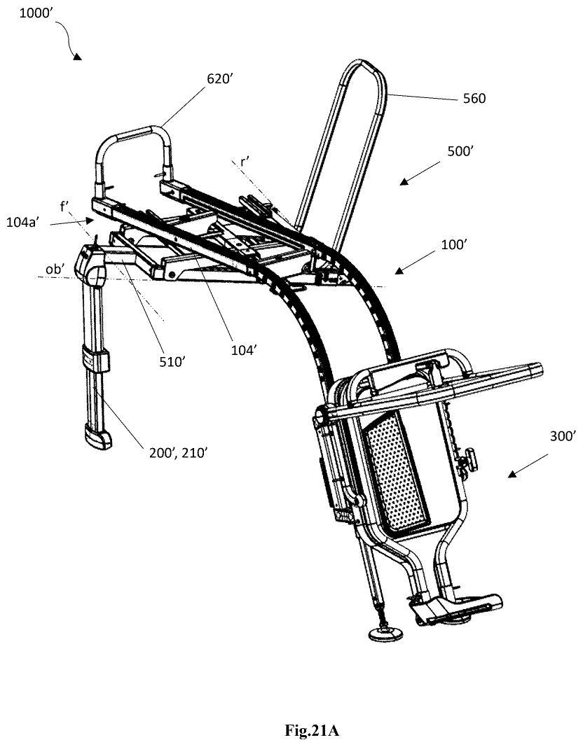

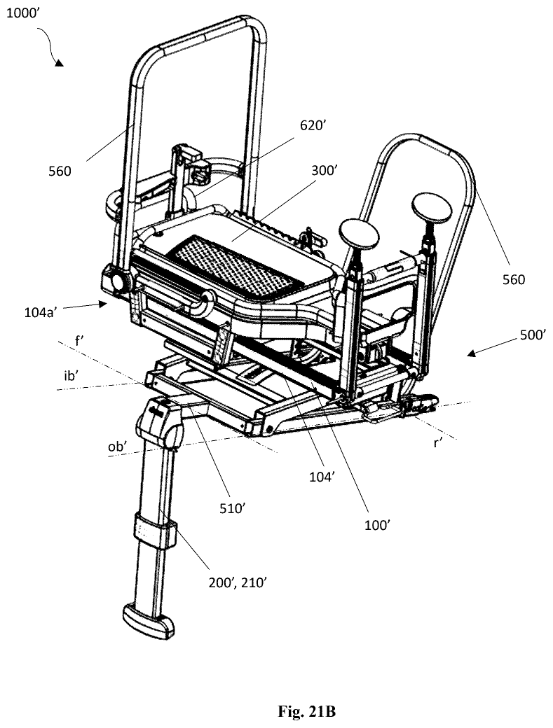

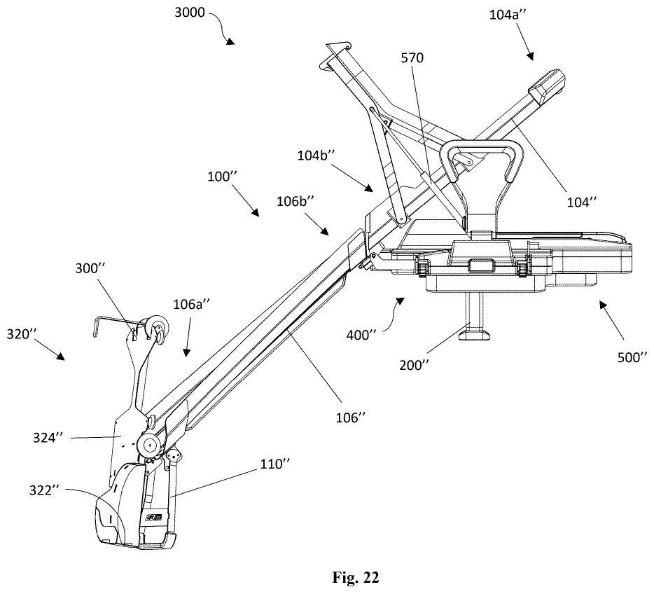

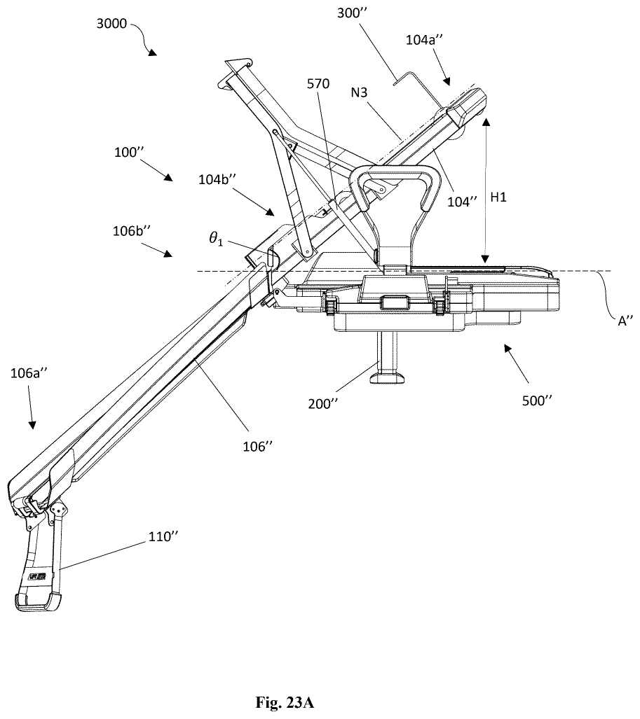

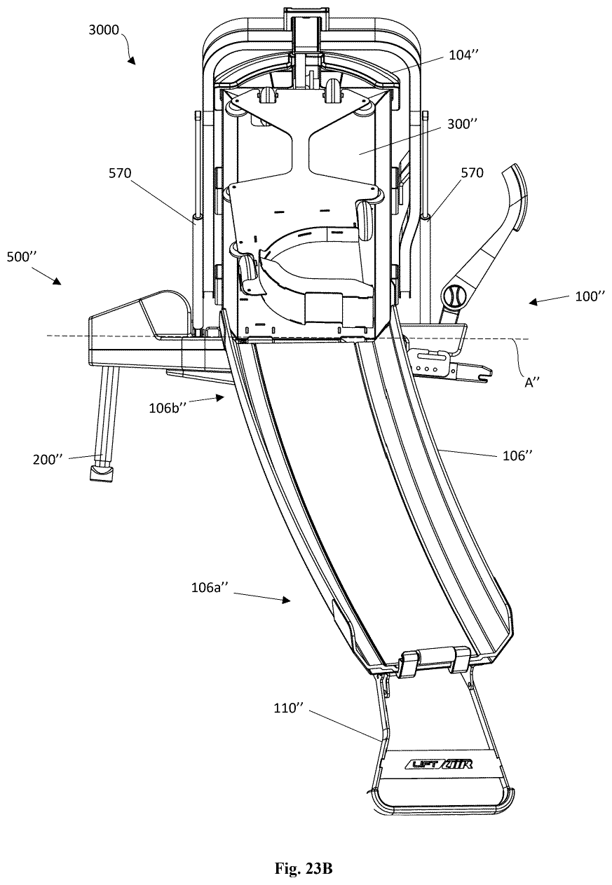

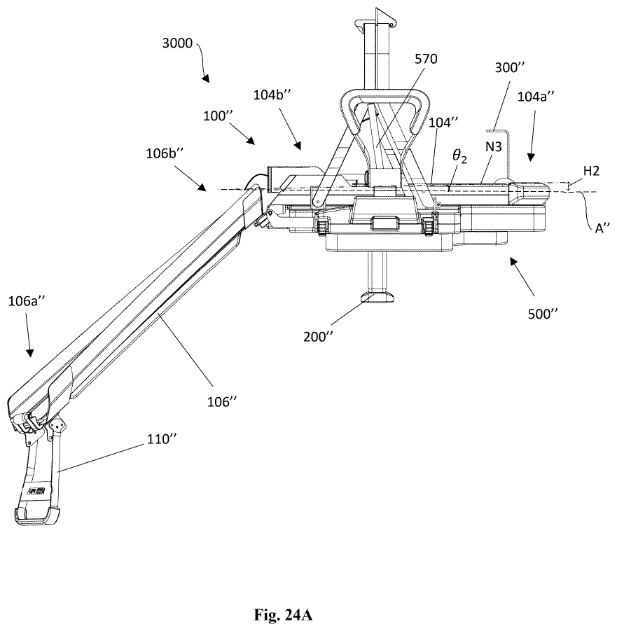

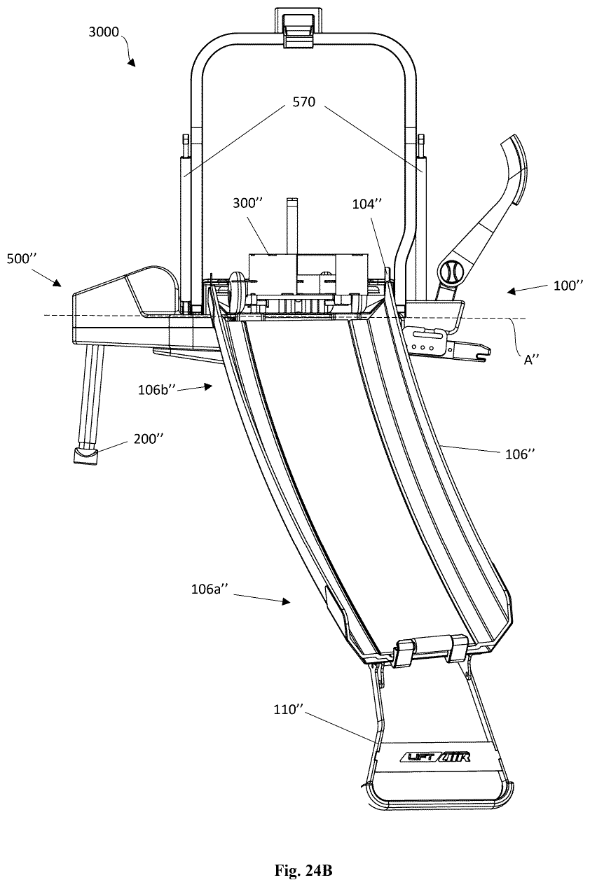

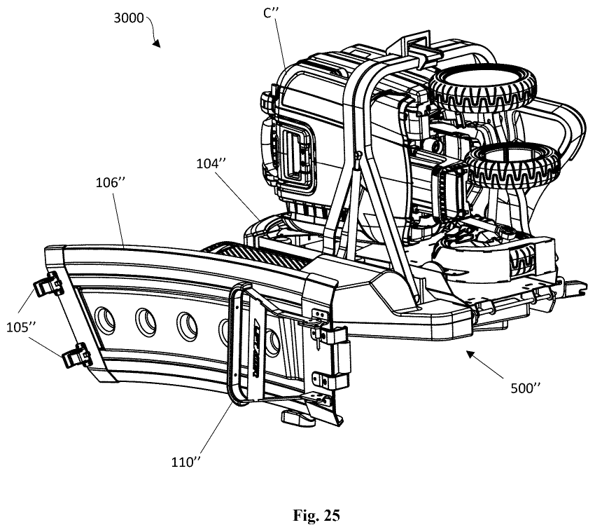

FIGS. 13A and 13B respectively illustrate the cargo carrying member 300 of FIG. 10, in the initial and inclined states thereof. The cargo carrying member 300 comprises a cargo fixing apparatus 320 having a bottom support surface 322 and a side supporting surface 324.

FIGS. 14A and 14B respectively illustrate the cargo carrying member 300′ partially shown in FIGS. 11 and 12, in its initial and inclined states. The cargo carrying member 300′ includes a cargo fixing apparatus 320′ that has a bottom support surface 322′, a side supporting surface 324′, and a track-facing surface 326′ (not seen, shown in FIG. 12). The cargo fixing apparatus 320′ comprises a first component 323′, which includes the track-facing surface 326′ on one side thereof and the side supporting surface 324′ on the other. It further comprises a second component constituted by a holding base 325′ having the bottom support surface 322′ on one end and a latch designed to engage a part of the cargo on the opposite end. A lever member 328 is connected to each of the first and second components 323′, 325′, and is operable to move the second component 325′ relative to the first, thereby transitioning the cargo carrying member 300′ between its initial and inclined states.

As mentioned earlier, an interior track component described heretofore may be fixedly mounted to a base according the presently disclosed subject matter, such that the central axis thereof is parallel to or coincident with the base longitudinal axis. The interior track component may be mountable directly to the cargo facing surface of the base. The base can be mountable on a rear seat having a seat longitudinal axis such that the base longitudinal axis is parallel to the seat longitudinal axis, and the seat facing surface faces towards the seat. The inboard end of the interior track component can be adjacent to the inboard side boundary of the base, and the outboard end of the track component can be adjacent to the outboard side boundary of the base.

FIG. 15 illustrates a perspective view of a base 500 with the interior track component 104 illustrated in FIG. 7A mounted thereto. The base 500 comprises two connection elements in the form of ISOFIX connectors 502 operable to detachably and securely attach to ISOFIX anchorage points of a vehicle, and two connection elements in the form of slots 504 shaped for a seat belt to be strapped therethrough. The base 500 has a base longitudinal axis B1, front and rear boundaries f and r, and outboard and inboard side boundaries ob and ib. The connection elements 502, 504 are disposed adjacent the rear boundary r of the base 500, and a support receiving port 510 is located adjacent the front boundary f, for engaging a front support member 200. The inboard end 104a of the interior track component is adjacent to the inboard side boundary ib of the base, and the outboard end 104b of the interior track component is adjacent to the outboard side boundary ob of the base 500. The base 500 further comprises a seat facing surface (not seen) and a cargo facing surface 530.

FIG. 16A illustrates another example of a base designated 500′, designed to receive the interior track component 104′ illustrated in FIGS. 6A to 6E thereon. The base 500′ has a base longitudinal axis B′, front and rear boundaries f′ and r′, and outboard and inboard side boundaries ob′ and ib′. The base 500′ comprises two connection elements in the form of ISOFIX connectors 502′ operable to detachably and securely attach to ISOFIX anchorage points a vehicle and disposed adjacent the rear boundary r′ of the base 500′. A support receiving port 510′ is located adjacent the front boundary f′, for engaging a front support member.

In some examples of the above-described base, the two connection elements can each further comprise a slot shaped for a seat belt to be strapped therethrough.

An interior track component described heretofore may be rotatably mounted to a base according the presently disclosed subject matter. In such examples, the interior track component can have a transverse orientation, wherein the interior track component extends transversely to the base longitudinal axis at least when seen in the plan view. The interior track component can be configurable between the transverse orientation, and an aligned configuration wherein the interior track component extends parallel to said base longitudinal axis at least when seen in the front view. The interior track component can be rotatable relative to the base between these transverse and aligned orientations.

The interior track component can additionally be slidable along the base longitudinal axis, when in its aligned orientation, between an intermediate storage position when it is first brought from transverse orientation into the aligned orientation, and a final storage position in which the interior track inboard end is moved closer to the inboard boundary of the base than in the intermediate storage position.

The base can comprise any appropriate means to provide either or both the above-described pivoting and sliding of the interior track component relative thereto. In some examples, the base can comprise a rail linkage system that comprises a pivot mechanism to facilitate rotation of the track component and a sliding component along which the interior track component can slide. In some examples, the rail linkage arrangement can comprise an extendable arm comprising a pivot point and a locking portion operable to receive a corresponding locking element of the interior track portion at different orientations. The interior track portion can be pivotably connected to the extendable arm at the pivot point, enabling it to rotate around this point. As the arm extends or retracts, the interior track portion can move with the arm, allowing the sliding movement between the intermediate and final storage positions.

FIGS. 16B-16D illustrate plan views of the interior track component 104′ illustrated in FIGS. 6A-6E, rotatably mounted to the base 500′, in the transverse orientation, and the intermediate storage position and the final storage position of the aligned orientations thereof, respectfully. As shown in FIG. 16B, when the interior track component 104′ is in its transverse orientation, the portion of the track central axis thereof designated C1 extends transversely to the base longitudinal axis B′. The interior track component 104′ can be brought from it's transverse orientation to its aligned orientation, shown in FIGS. 6B and 6C, in which it extends parallel to the base longitudinal axis B′. The interior track component 104′ is slidable between the intermediate storage position thereof, shown in FIG. 16B, and the final storage position thereof, shown in FIG. 16C. The base 500′ comprises a rail linkage arrangement 550 comprising an extendable arm 552 having a pivot member 554, and a locking portion 556 operable to receive a corresponding locking element (not shown) of the interior track portion 104′ at different orientations thereof. The interior track portion 104′ is pivotably connected to the extendable arm 552 at the pivot point 554. Furthermore, the inboard end 104a′ of the interior track component 104′ is adjacent to the inboard side boundary ib′ of the base, and the outboard end 104b′ of the interior track component 104′ is adjacent to the outboard side boundary ob′ of the base 500′.

In most vehicles, the seat surface of a passenger seat is oriented at a declining angle from the front end to the rear end thereof. In order to maximize the efficiency of an example of a system according to the presently disclosed subject matter which comprises an interior track component mounted to the base, it is advantageous to maintain the interior track component in a level position. In other words, the interior track component should not be inclined at an angle relative to the horizon, at least along the majority thereof. To ensure both that the seat engaging portion of the base lies flat along a seat and that the interior track component is level, the base can comprise an orientation mechanism. The seat orientation mechanism can allow the seat facing surface of the base to maintain parallel alignment with the seat surface while enabling the cargo facing surface to be rotatable or inclinable relative thereto. This functionality can be achieved through various means, such as a pivoting mechanism between the seat facing surface and the cargo facing surface. Thus, the orientation mechanism can comprise pivot pins, and a latch arrangement to lock the seat facing surface and cargo facing surface in a desired position relative to each other. The base can comprise at least one shell element that covers at least a part of the orientation mechanism.

FIG. 17 illustrates a perspective view of the base 500 illustrated in FIG. 16. The base 500 comprises an orientation mechanism 540 constituted by pivot pins 542 that are connected to the seat facing surface 520 and the cargo facing surface 530, and a latch mechanism 544.

Similarly, FIG. 18 illustrates a perspective view of the base 500′ illustrated in FIGS. 16A-16D . The base 500′ comprises an orientation mechanism 540′ constituted by pivot pins 542′ that are connected to the seat facing surface (not seen) and the cargo facing surface 530′, and a latch mechanism 544′.

A system 1000 according to the presently disclosed subject matter can comprise the base 500 illustrated with reference to FIG. 15, and the track 100, cargo carrying member 300 and moving mechanism 400 described with reference to FIGS. 9A and 9B. FIG. 19 illustrates a perspective view of the above system 1000, wherein the cargo carrying member 300 is in the extended position thereof. The base 500 comprises a shell element 546 that covers the entire orientation mechanism.

As a system according to the presently disclosed subject matter is mountable in the passenger compartment of a vehicle, it is desirable that the system as well as any cargo introduced into the vehicle be safely securable to the seat. Thus, the system can include at least one safety measures to prevent movement of cargo at least indirectly positioned on the seat of a vehicle/car, in at least one direction.

Such safety measures can include, for example a safety net or cover configured to be tightly wrapped around the system and any cargo associated therewith and tied to the seat. Alternatively, the measures can include multiple straps configured to be wrapped and tightened around parts of the system and/or cargo as well as the seat. Further alternatively, the system can comprise a rigid cage member operable to surround the entire system and any cargo associate therewith, the cage member being connectable to the seat.

Further alternatively or additionally, the safety measures can include at least one safety barrier. The at least one safety barrier can comprise one or more of an inboard side safety barrier, a front safety barrier, and an upper safety barrier. These safety barriers may be constituted by three or more separate elements, or less than three elements wherein a single element can constitute more than one safety barrier. For example, the upper safety barrier and at least a portion of the front safety barrier can be formed as a unitary body.

The safety measure may also include an anti-rebound bar, which can comprise a vertical extension extending from the base at the rear boundary. This bar can help prevent backward movement and absorb forces, reducing the risk of rebound of the system and cargo during sudden stops or impacts, thereby providing an additional layer of protection.

In a system comprising a track of the kind described above wherein the exterior track component is detachable from the interior track component, the unitary body can be constituted by the body of the exterior track component, when the exterior track component detached from said exterior track end of said interior track component. A front support member, according to the presently disclosed subject matter can have a lower portion that constitutes a front support leg, and an upper portion that constitutes a front movement preventing member. The upper portion can have a front receiving portion operable to receive a portion of a safety barrier element. A side movement preventing member may be connected to or integrally formed with the inboard end of the interior track component, to prevent movement of the cargo in the inboard direction. The system can further include an upper fixation member to which at least one safety barrier is mountable to. The upper fixation member can be securable to the backrest of the seat of the vehicle to which the system is mounted via ISOFIX connection. To this end, the upper fixation member can have an attachment port thereon to which a belt having an ISOFIX connector at one end thereof can be attached. Alternatively, or additionally, the upper fixation member can be connectable to the headrest of a seat and/or to the base for example via straps or a belt.

FIG. 20 illustrates a system 2000 comprising the base 500, track 100, moving mechanism 400 and cargo carrying member 300 of the system 2000 illustrated in FIG. 11, further comprising elements constituting safety barriers. The system 2000 comprises a front support member 200 mounted to the support receiving port 510 at the front end of the base 500. The front support member 200 has a lower portion 210 that constitutes a front support leg for the base, and an upper portion 220 that constitutes a front movement preventing member 610 of the base. The upper end 610a of the front movement preventing member 610 comprises a fixation member receiving port, configured to receive the fixation member 105 (best seen in FIG. 12A) at the proximal end 106b of the exterior track component 106.A side movement preventing 620 member is attached to the inboard end 104a of the interior track component 104.

FIG. 20B illustrates the system shown in FIG. 20A, wherein the cargo carrying member 300 is in the retracted position thereof, and the exterior track component 106 is disconnected from the interior track component 104 and is serving as an upper and partial front movement preventing barrier. The proximal end 106b of the exterior track component 106 is connected to the upper portion 610a of the front movement preventing member 610, and the distal end 106a of the exterior track component 106 is connected to the upper fixation member 630. The upper fixation member 630 has an attachment port 632 to which a belt having an ISOFIX connector at one end thereof can be attached.

Reference will now be made to FIGS. 21A and 21B which illustrate perspective views of another example of a system according to the presently disclosed subject matter, designated 1000′, wherein the cargo carrying member is respectfully in the extended and retracted positions thereof. The system 1000′ comprises the base 500′ illustrated in FIGS. 16A-16D and FIG. 18, the track 100′ illustrated in FIGS. 6A to 6E, and the cargo carrying member 300′ and moving mechanism (not seen) illustrated in FIGS. 11 and 12. The system 1000′ further comprises a front support member 200′ mounted to the support receiving port 510′ at the front end of the base 500′. The front support member 200′ constitutes a front support leg 210′ for the base. A side movement preventing 620′ member is attached to the inboard end 104a′ of the interior track component 104′. The base 500′ comprises an anti-rebound bar (not shown in FIGS. 16A-16D) designated 560 extending upward from the rear boundary r′ of the base 500′.

In some examples of the presently disclosed subject matter, the system may include a base locking mechanism designed to prevent movement of the cargo carrying member relative to the base once it reaches its maximally retracted position. The base locking mechanism can comprise any suitable components or arrangement. The base locking mechanism can comprise one or more first locking member positioned on the base and one or more corresponding second locking member positioned on the cargo carrying member. These first and second locking members can be designed to engage with each other to prevent movement in at least one direction. In particular, they can be configured to prevent forward movement in the front-to-rear direction, which is critical in scenarios such as sudden deceleration or a collision.

In some examples, the first locking member can be a latch or hook, while the second locking member can be a corresponding slot or eyelet. In another examples, the one or more first locking members can comprise a T-shaped profile, and the one or more second locking can comprise a slot shaped to receive the T-shaped profile.

The system 1000′ comprises a locking mechanism 700 designed to prevent movement of the cargo carrying member 300′ relative to the base 500′ once it reaches its maximally retracted position. As seen in FIG. 12, the cargo carrying member 300′ of the system 1000′ comprises two T-shaped profiles 702 extending from the track facing surface 326′ thereof. As best seen in FIG. 18, the base 500′ of the system 1000′ comprises two slots 704 shaped to receive the T-shaped profile 702. When the cargo carrying member 300′ is moved into its maximally retracted position, and the interior track component 104′ is in its final storage position in the aligned orientation thereof, the T-shaped profiles 702 are slidingly introduced into the respective T-shaped slots 704.

With reference to previously described constraints defining the shape of the path along which the cargo carrying member in a system according to the present disclosure can be moved, such constraints can be overcome by providing a track with a structure allowing the cargo carrying member to be moved in an inclined orientation, not only along the path distal portion, but also along the path proximal portion.

In some examples of the presently disclosed subject matter, the constraints described above with reference to FIGS. 2B, 3A and 3B can be addressed by enabling the cargo carrying member to remain in an inclined orientation relative to the base plane not only along the path distal portion, but also along the path proximal portion.

To this end, according to a further aspect of the presently disclosed subject matter, the interior track component can be pivotably mounted to the base adjacent the interior track outboard end. The interior track component can be pivotable between an inclined orientation and a planar orientation.

In the inclined orientation, the interior track inboard end can be spaced from the base plane to a first height, and the interior track component can be oriented at a first inclination angle relative to the base plane. The inclination angle can be defined between a line coincident with the interior track component central axis and a reference line parallel to the base plane. The inclined orientation of the interior track component can define an inclined orientation of the path proximal portion, thereby providing the cargo carrying member with an inclined orientation relative to the base plane when moving along the path proximal portion. In this manner, the cargo carrying member can maintain an inclined orientation relative to the base plane when moving along both the path distal portion and the path proximal portion, and when transitioning therebetween.

In the planar orientation, the interior track inboard end can be spaced from the base plane to a second height that is smaller than the first height, and the interior track component can be oriented at a second inclination angle relative to the base plane, wherein the second inclination angle is smaller than the first inclination angle. In some examples, the second inclination angle can be approximately zero.

In both the inclined and planar orientations, the interior track outboard end can maintain a location thereof relative to the cargo facing surface.

Due to the pivotable structure of the interior track component described above, the exterior track component can be shorter than in the systems described above. The distal end of the exterior track component can be positioned closer to the vehicle relative to systems having non-inclined proximal path portions, and can be disposed at a steeper incline relative to the horizontal. In such systems, the exterior track distal end can be positioned at a height above the surface from which the cargo is to be raised, such that the track need not extend all the way to the surface. The cargo carrying member can be configured to pivot about the exterior track distal end between a loading position, in which the cargo fixing apparatus thereof is in the initial state as described above with the bottom support surface oriented horizontally to facilitate loading of cargo thereon, and a travelling position, in which the cargo fixing apparatus is in the inclined state as described above and the cargo carrying member is aligned with the exterior track component for movement therealong. A ground support member, as described above, can be connected to the exterior track distal section and can extend therefrom downwardly to engage the surface from which the cargo is to be raised, thereby stabilizing the exterior track component while the cargo carrying member pivots about the exterior track distal end.

The exterior track component can comprise a fixation member at the exterior track proximal end thereof, the fixation member being operable to detachably attach the exterior track proximal end to the interior track outboard end of the interior track component. The fixation member can be constituted by any suitable attachment means, for example a clamp, latch, pin-and-slot arrangement, or quick-release mechanism.

In some examples of the presently disclosed subject matter, the moving mechanism can comprise a hoist apparatus including at least one cable, an example of which is previously described and shown in reference to FIGS. 9A and 9B. The cable can be operable to transmit tensile forces to pull the cargo carrying member toward the base along the track. The hoist apparatus can comprise a motor, a spool about which the cable is windable, a cable having a spool end and an anchorable end, and an anchoring member to which an anchorable end is fixedly connected. The motor and spool can be mounted on the cargo carrying member, with the anchoring member mounted on the base or the interior track component adjacent the inboard end thereof. Alternatively, the motor and spool can be mounted on the base or interior track component, with the anchoring member disposed on the cargo carrying member.

According to a still further example of the presently disclosed subject matter, which can be used in any of the examples described above or below where the interior track component is pivotably mounted to the base, the system can further comprise at least one biasing element operably connecting the base and the interior track component. The biasing element can bias the interior track component toward the inclined orientation. The system can be operable such that, after the cargo carrying member reaches the maximally retracted position thereof, continued retraction of the cable compresses the biasing element and pivots the interior track component toward the planar orientation. During movement of the cargo carrying member away from the maximally retracted position, extension of the cable can permit the biasing element to return the interior track component toward the inclined orientation, which can occur prior to the cargo carrying member reaching the path distal portion. The biasing element can be constituted by a spring, gas strut, elastomeric member, or other suitable resilient element.

A system according to any of the above aspects relating to a pivotable interior track component can be similar to the systems described above in all their features except for the structure of the track and the corresponding moving mechanism. Reference will now be made to FIGS. 22 to 25 which illustrate views of one such example of a system, designated 3000.

FIG. 22 illustrates a side view of the system 3000 with a cargo carrying member 300″ in a maximally extended position thereof at an exterior track distal end 106a″. The system 3000 comprises a base 500″ having a cargo facing surface defining a base plane A″ and front support member 200″, and a track 100″ comprising an interior track component 104″ and an exterior track component 106″. The interior track component 104″ has an interior track inboard end 104a″ and an interior track outboard end 104b″, and the exterior track component 106″ is detachably attachable to the interior track outboard end 104b″ at the exterior track proximal end 106b″ adjacent to the interior track outboard end 104b″′. The exterior track component 106″ comprises a fixation member 105″ at the exterior track proximal end 106b″, the fixation member 105″ being operable to detachably attach the exterior track component 106″ to the interior track outboard end 104b″. The interior track component 104″ is pivotably mounted to the base 500″ adjacent the interior track outboard end 104b″, and has an interior track component central axis N3. The interior track component 104″ is pivotable between an inclined orientation, shown in FIGS. 22, 23A and 23B, and a planar orientation, shown in FIGS. 24A, 24B and 25, wherein in both orientations the interior track outboard end 104b″ maintains a location thereof relative to the cargo facing surface of the base 500″.

With continued reference to FIG. 22, the system 3000 further comprises a moving mechanism 400″ comprising a hoist apparatus similar to that described above with reference to FIGS. 9A and 9B. The system 3000 further comprises a biasing element 570 operably connecting the base 500″ and the interior track component 104″ so as to bias the interior track component 104″ toward the inclined orientation.

The cargo carrying member 300″ comprises a cargo fixing apparatus 320″ having a bottom support surface 322″ and a side support surface 324″. In the configuration shown in FIG. 22, the cargo fixing apparatus 320″ is in the initial state thereof, with the bottom support surface 322″ oriented horizontally to facilitate loading of cargo thereon. The cargo carrying member 300″ is configured to pivot about the exterior track distal end 106a″ from the initial state (shown in FIG. 22) to the inclined state (shown in FIGS. 23-25) in which the cargo carrying member 300″ is aligned with the exterior track component 106″ for movement therealong. A ground support member 110″ is in a deployed position thereof, extending downwardly from the exterior track distal end 106a″ to engage the surface from which the cargo is to be raised, thereby stabilizing the exterior track component 106″ while the cargo carrying member 300″ pivots about the exterior track distal end 106a″.

FIGS. 23A and 23B illustrate side and front views, respectively, of the system 3000 with the interior track component 104″ in the inclined orientation thereof and the cargo carrying member 300″ in the inclined state and maximally retracted position thereof. In the inclined orientation of the interior track component 104″, the interior track inboard end 104a″ is spaced from the base plane A″ to a first height H1 and the interior track component 104″ is oriented at a first inclination angle θ1 defined between an interior track component central axis N3 and the base plane A″. In the configuration shown in FIGS. 23A and 23B, the biasing element 570 is in an extended state and the cable (not seen) is at a first retraction length.

FIGS. 24A and 24B illustrate side and front views, respectively, of the system 3000 with the interior track component 104″ in the planar orientation thereof and the cargo carrying member 300″ in the inclined state and maximally retracted position thereof. In the planar orientation, the interior track inboard end 104a″ is spaced from the base plane A″ to a second height H2 smaller than the first height H1, and the interior track component central axis N3 is oriented at a second inclination angle θ₂ relative to the base plane A″, the second inclination angle θ₂ being smaller than the first inclination angle θ₁. In the configuration shown in FIGS. 24A and 24B, the biasing element 570 is in a compressed state and the cable (not seen) is at a second retraction length that is shorter than the first retraction length.

FIG. 25 illustrates a perspective view of the system 3000 in a storage state thereof, with an exemplary cargo C″ loaded on the cargo carrying member 300″. In the storage state, the cargo carrying member 300″ is in the inclined state and maximally retracted position thereof, the interior track component 104″ is in the planar orientation thereof, and the exterior track component 106″ is detached from the interior track component 104″ and positioned adjacent thereto. The fixation member 105″ at the exterior track proximal end of the exterior track component 106″ is disengaged from the interior track outboard end 104b″ of the interior track component 104″. In addition, the ground support member 110″ of the system 3000 is shown in a folded position thereof. The biasing element 570 is in the compressed state and the cable (not seen) is at the second retraction length.

In operation of the above-described system 3000, when loading cargo into the vehicle, from the state shown in FIG. 22, the cargo carrying member 300″ is positioned at the exterior track distal end 106a″ with the cargo fixing apparatus 320″ in the initial state thereof, the bottom support surface 322″ being oriented horizontally to receive the cargo. Once the cargo is loaded onto the cargo fixing apparatus 320″, the moving mechanism 400″ is operated and the cargo carrying member 300″ is hoisted and subsequently pivoted about the exterior track distal end 106a″ from the initial state to the inclined state, thereby aligning the cargo carrying member 300″ with the exterior track component 106″ for movement therealong.

Once the cargo carrying member 300″ is in the inclined state thereof and aligned with the exterior track component 106″, the moving mechanism 400″, by way of the cable being wound onto the spool (not seen), continues to hoist the cargo carrying member along the exterior track component 106″ toward the interior track component 104″. Meanwhile, the biasing element 570 maintains the interior track component 104″ in the inclined orientation thereof.

After a majority of the cargo carrying member 300″ reaches the interior track component 104″, and optionally only after reaching the maximally retracted position thereof as shown in FIGS. 23A and 23B, continued retraction of the cable compresses the biasing element 570 and pivots the interior track component 104″ from the inclined orientation toward the planar orientation shown in FIGS. 24A and 24B. This transition lowers the interior track inboard end 104a″ from the first height to the second height, reducing the overall height of the system 3000 for a more compact storage configuration.

In the reverse mode of operation, when unloading cargo from the vehicle, while a majority of the cargo carrying member 300″ is located on the track interior component 104″, extension of the cable allows the biasing element 570 to return the interior track component 104″ toward the inclined orientation. The cargo carrying member 300″ then descends under the influence of gravity from the interior track component 104″ to the exterior track component 106″, with the moving mechanism 400″ controlling the rate of descent by controllably unwinding the cable. Upon reaching the exterior track distal end 106a″, the cargo carrying member 300″ is pivoted about the exterior track distal end 106a″ from the inclined state to the initial state to facilitate unloading of the cargo. To transition the system 3000 to the storage state shown in FIG. 25, the fixation member 105″ is disengaged from the interior track outboard end 104b″, the exterior track component 106″ is detached from the interior track component 104″ at the fixation member 105″ and positioned adjacent thereto, and the ground support member 110″ is moved to the folded position thereof.

It should be understood that while the system 3000 illustrated in FIGS. 22 to 25 comprises a cable-based moving mechanism, designated 400″, the moving mechanism need not comprise a cable system. For example, the moving mechanism can alternatively comprise a rack-and-pinion mechanism as described above with reference to FIGS. 11 and 12, or any other suitable motorized or manually operated mechanism.

It will be appreciated that the specific structural and functional features of the system 3000 can be combined with features of the other systems described herein, as would be apparent to a person skilled in the art.

In systems comprising a pivotable interior track component such as the system 3000 described above, when the interior track component is in the inclined orientation thereof, movement of the cargo carrying member in a direction away from the base can occur under the influence of gravity along both the interior track component and the exterior track component. Accordingly, unlike systems having a non-inclined interior track component, such as the systems 1000 and 1000′ described above with reference to FIGS. 19 and 21A-21B, which may require a secondary moving mechanism or manual assistance to move the cargo carrying member from the retracted position toward the extended position as described above, systems having a pivotable interior track component in the inclined orientation can permit the cargo carrying member to descend under the influence of gravity along the entire path from the retracted position to the extended position. In such systems, the cable, spool, and motor assembly can be operable to control the rate at which the cable unwinds so as to control gravitational descent of the cargo carrying member along the track.

It will also be appreciated that a system according to the presently disclosed subject matter, and particularly, of any of the examples presented herein with respect to mounting on a seat of a passenger compartment of a vehicle, can alternatively be mountable in a trunk compartment of a vehicle. In such an arrangement, the base can have at least one connection element operable to detachably and securely attach the base to at least one anchorage point of the vehicle provided in the trunk compartment, for example ISOFIX anchorage points and/or tether anchors, so as to allow introducing cargo into and removing cargo from the trunk compartment. In such a trunk-mounted arrangement, the system can operate in the same general manner as described herein with respect to a seat-mounted arrangement, including use of the moving mechanism and, where provided, a cargo carrying member and/or track, mutatis mutandis. It will be appreciated that implementation in a trunk compartment may require modifications to the system and/or its mounting arrangement, for example in view of differences in available clearance, anchoring locations, and trunk floor geometry, as would be apparent to a person skilled in the art.

1. A system for introducing cargo onto, and removing it from, a seat of a passenger compartment of a vehicle through a door frame of a corresponding vehicle side door, the seat having a seat longitudinal axis and a seat upper surface having a dimension defining a seat depth perpendicular to the longitudinal axis, the seat having at least one safety element for at least indirectly fastening to the seat a passenger occupying the seat, the system comprising at least in operation:
a base having a base longitudinal axis, a seat facing surface and an opposite, cargo facing surface defining a base plane, the base further having at least one connection element detachably securable to the seat by means of said at least one safety element, and
a moving mechanism operable for moving the cargo at least along a part of a path extending via the door frame between a surface at the exterior of the vehicle, from which the cargo is to be raised, and the base.

2. The system according to claim 1, wherein said base longitudinal axis is parallel to the seat longitudinal axis and said seat facing surface is parallel to the upper surface of the seat, said base further having:
front and rear boundaries defining a width of the base which extends at least partially along the depth of the seat when the base is secured thereto; and
inboard and outboard side boundaries defining therebetween a length of the base along the base longitudinal axis;
said system further comprising:
a cargo carrying member moveable with respect to the base along said path, between a retracted position in which the cargo carrying member is positioned at least partially above the cargo facing surface of the base, and an extended position in which said cargo carrying member is spaced from the cargo facing surface of the base at least along the longitudinal axis thereof at least in a plan view of the system, to allow the cargo carrying member to be located outside of the vehicle, and
said moving mechanism operable for moving the cargo carrying member between the extended and retracted positions via the door frame, at least along a part of said path.

3. The system according to claim 2, wherein said path comprises a path proximal portion associated with a maximally retracted position of the cargo carrying member, and a path distal portion associated with a maximally extended position of the cargo carrying member.

4. The system according to claim 3, wherein the system has an operational state in which the system is operable for introducing cargo onto, and removing the cargo from, a seat of a passenger compartment of a vehicle through a door frame of a corresponding vehicle side door, and a storage state in which at least a majority of said cargo carrying member with or without said cargo is located within said boundaries of said base.

5. The system according to claim 4, wherein the system, in said operational state thereof, comprises a track having a longitudinal central track axis defining at least a portion of the path.

6. The system according to claim 5, wherein said track comprises:
an interior track component mounted to the base and extending along an interior portion of the longitudinal central track axis defining the path proximal portion, the interior track component having an interior track inboard end and an interior track outboard end, and
an exterior track component extending along an exterior portion of the longitudinal central track axis defining the path distal portion and having an exterior track proximal section with an exterior track proximal end adjacent to the interior track outboard end, and an exterior track distal section with an exterior track distal end spaced from the exterior track proximal end along the track central axis.

7. The system according to claim 6, wherein the exterior portion of the longitudinal central track axis defines an obtuse angle with said base plane, providing the cargo carrying member with an inclined orientation relative to said base plane when moving along the path distal portion.

8. The system according to claim 7, wherein the interior track component is mounted to the base so that at least a portion of the interior track component is pivotable between:
an inclined orientation in which the interior track inboard end is spaced from said base plane to a first height at least when the cargo carrying member is at least partially in the extended position thereof, said inclined orientation of the interior track component defining an inclined orientation of the path proximal portion allowing the cargo carrying member to maintain the inclined orientation thereof when moving from the path distal portion to the path proximal portion, and vice versa; and
a planar orientation in which the interior track inboard end is spaced from the base plane to a second height smaller than the first height at least after the cargo carrying member reaches the maximally retracted position thereof;
wherein in both orientations the interior track outboard end maintains a location thereof relative to the cargo facing surface.

9. The system according to claim 8, further comprising at least one biasing element operably connecting the base and the interior track component, the at least one biasing element biasing the interior track component toward said inclined orientation.

10. The system according to claim 9, wherein the moving mechanism comprises a hoist apparatus including at least one cable windable on a spool and attached to the cargo carrying member at least when the system is in the operational state thereof.

11. The system according to claim 10, wherein upward movement of the cargo carrying member along the path distal portion and path proximal portion is provided by means of retraction of the cable until the cargo carrying member reaches a stage at which at least continued retraction of the cable causes compression of the at least one biasing element to pivot the interior track component from the inclined orientation toward the planar orientation.

12. The system according to claim 11, wherein the at least one biasing element is configured to maintain the interior track component in the inclined orientation thereof, at any weight of cargo for which the system is designed, when at least a majority of the cargo carrying member is located along the path proximal portion.

13. The system according to claim 12, wherein during movement of the cargo carrying member from the maximally retracted position thereof along the path proximal portion, extension of the cable permits the at least one biasing element to bias the interior track component toward the inclined orientation thereof prior to the cargo carrying member reaching the path distal portion.

14. The system according to claim 1, wherein said at least one connection element is engageable with at least one anchorage point constituting said at least one safety element of the vehicle, such as an ISOFIX anchorage point.

15. The system according to claim 14, wherein the base has a rear portion and a front portion including the respective rear and front boundaries of the base, and wherein said at least one connection element is securely fixed to the rear portion of the base so as to project rearwardly from the rear boundary of the base for engaging with the corresponding at least one safety element.

16. The system according to claim 6, wherein said cargo carrying member comprises a track facing surface which faces the track along the entire movement of the member, and a cargo fixing apparatus operable to fixedly receive the cargo, said cargo fixing apparatus maintaining a constant orientation with respect to the track facing surface during movement of the cargo carrying member between the extended and retracted positions of the cargo carrying member.

17. The system according to claim 16, wherein said cargo fixing apparatus comprises a bottom support surface operable to contact a first side of the cargo and a side support surface operable to contact a second side of the cargo at least when the cargo carrying member with the cargo is moved along said path.

18. The system according to claim 17, wherein said cargo fixing apparatus is manipulable between an initial state, in which the bottom support surface is oriented horizontally facilitating cargo loading thereon and is inclined relative to the track facing surface at a first angle, and an inclined state in which the bottom surface is inclined at a second angle smaller than said first angle relative to the track facing surface.

19. The system according to claim 18, wherein when said cargo fixing apparatus is in the inclined state thereof, said bottom and side support surfaces are angled with respect to its orientation in the initial state of the unit so as to allow at least a part of the cargo weight to be borne by the side support surface.

20. The system according to claim 6, wherein said system further comprises a ground support member, wherein, at least when said system is in its operational state, the ground support member is connected to the exterior track distal section of the exterior track component and extends therefrom downwardly to engage the surface from which the cargo is to be raised.
